(19) United States
(12) Patent Application Publication
(10) Pub. No.: US 2025/0337964 A1
(43) Pub. Date: Oct. 30, 2025

(54) ENCODING METHOD, DECODING METHOD, ENCODER, DECODER AND STORAGE MEDIUM

(71) Applicant: GUANGDONG OPPO MOBILE TELECOMMUNICATIONS CORP., LTD., Dongguan (CN)

(72) Inventor: ZeXing SUN, Dongguan (CN)

(21) Appl. No.: 19/258,565

(22) Filed: Jul. 2, 2025

Related U.S. Application Data
(63) Continuation of application No. PCT/CN2023/072065, filed on Jan. 13, 2023.

(51) Int. Cl. H04N 19/96; H04N 19/103; H04N 19/119; H04N 19/147; H04N 19/597; H04N 19/70

(52) U.S. Cl. CPC H04N 19/96; H04N 19/103; H04N 19/119; H04N 19/147; H04N 19/597; H04N 19/70

(57) ABSTRACT

Embodiments of the present disclosure provide a decoding method. A decoder determines nodes in a level obtained after octree partitioning as one node group; decodes a bitstream to determine mode flag information corresponding to a current node group among at least one node group; and determines a prediction value of a node in the current node group according to a decoding mode indicated by the mode flag information.

### CROSS-REFERENCE TO RELATED APPLICATION

This application is a Continuation Application of International Application No. PCT/CN2023/072065 filed on Jan. 13, 2023, which is incorporated herein by reference in its entirety.

### TECHNICAL FIELD

Embodiments of the present disclosure relate to the technical field of point cloud compression, and in particular, to an encoding and decoding method, an encoder, a decoder and a storage medium.

### BACKGROUND

In a geometry-based point cloud compression (G-PCC) encoding and decoding framework or a video-based point cloud compression (V-PCC) encoding and decoding framework provided by the moving picture experts group (MPEG), geometry information and attribute information of a point cloud are encoded separately. At present, geometry encoding and decoding of G-PCC can be divided into two approaches: octree-based geometry encoding and decoding and predictive tree-based geometry encoding and decoding. The octree-based geometry information coding mode can effectively encode the geometry information of the point cloud by utilizing the correlation between adjacent points in space. However, for some relatively planar nodes or nodes with planar characteristics, coding efficiency of the geometry information of the point cloud can be further improved by utilizing planar coding.

However, for nodes meeting a condition for planar coding, at present, whether to perform planar coding on nodes in each level is adaptively determined by utilizing the distribution density of the nodes in each level, without considering the geometric distribution characteristics of the point cloud in more detail, which results in low geometry coding efficiency of the point cloud.

### SUMMARY

The embodiments of the present disclosure provide an encoding and decoding method, an encoder, a decoder and a storage medium.

The technical solutions of the embodiments of the present disclosure may be implemented as follows.

In a first aspect, the embodiments of the present disclosure provide a decoding method. The method is applied to a decoder and includes:
performing partitioning processing on nodes to be processed to determine at least one node group corresponding to the nodes to be processed;
decoding a bitstream to determine mode flag information corresponding to a current node group among the at least one node group; and
determining a prediction value of a node in the current node group according to a decoding mode indicated by the mode flag information.

In a second aspect, the embodiments of the present disclosure provide an encoding method. The method is applied to an encoder and includes:
performing partitioning processing on nodes to be processed to determine at least one node group corresponding to the nodes to be processed;
determining a coding mode corresponding to a current node group among the at least one node group;
determining a prediction value of a node in the current node group according to the coding mode; and
determining mode flag information corresponding to the current node group according to the coding mode, and signalling the mode flag information into a bitstream.

In a third aspect, the embodiments of the present disclosure provide an encoder. The encoder includes a first determining unit and an encoding unit; where
the first determining unit is configured to perform partitioning processing on nodes to be processed to determine at least one node group corresponding to the nodes to be processed; and determine a coding mode corresponding to a current node group among the at least one node group; and
the encoding unit is configured to determine a prediction value of a node in the current node group according to the coding mode; and determine mode flag information corresponding to the current node group according to the coding mode, and signal the mode flag information into a bitstream.

In a fourth aspect, the embodiments of the present disclosure provide an encoder. The encoder includes a first memory and a first processor; where
the first memory is configured to store a computer program executable on the first processor; and
the first processor is configured to perform the method as described in the second aspect when executing the computer program.

In a fifth aspect, the embodiments of the present disclosure provide a decoder. The decoder includes a second determining unit and a decoding unit; where
the second determining unit is configured to perform partitioning processing on nodes to be processed to determine at least one node group corresponding to the nodes to be processed;
the decoding unit is configured to decode a bitstream; and
the second determining unit is configured to determine mode flag information corresponding to a current node group among the at least one node group; and determine a prediction value of a node in the current node group according to a decoding mode indicated by the mode flag information.

In a sixth aspect, the embodiments of the present disclosure provide a decoder. The decoder includes a second memory and a second processor; where
the second memory is configured to store a computer program executable on the second processor; and
the second processor is configured to perform the method as described in the first aspect when executing the computer program.

In a seventh aspect, the embodiments of the present disclosure provide a bitstream. The bitstream is generated by bit encoding based on information to be encoded; where the information to be encoded includes at least: mode flag information and first flag information.

In an eighth aspect, the embodiments of the present disclosure provide a non-transitory computer-readable storage medium. The non-transitory computer-readable storage medium has a computer program stored thereon; and the computer program, when executed, implements the method as described in the first aspect or the method as described in the second aspect.

### BRIEF DESCRIPTION OF THE DRAWINGS

FIG. 1A is a schematic diagram of a three-dimensional point cloud picture provided in the embodiments of the present disclosure.

FIG. 1B is a partially enlarged schematic diagram of a three-dimensional point cloud picture provided in the embodiments of the present disclosure.

FIG. 2A is a schematic diagram of a point cloud picture at different viewing angles provided in the embodiments of the present disclosure.

FIG. 2B is a schematic diagram of a data storage format corresponding to FIG. 2A provided in the embodiments of the present disclosure.

FIG. 3 is a schematic diagram of a network architecture of point cloud encoding and decoding provided in the embodiments of the present disclosure.

FIG. 4A is a schematic diagram of a composition framework of a G-PCC encoder provided in the embodiments of the present disclosure.

FIG. 4B is a schematic diagram of a composition framework of a G-PCC decoder provided in the embodiments of the present disclosure.

FIG. 5A is a schematic diagram of a low plane position in a Z-axis direction provided by the embodiments of the present disclosure.

FIG. 5B is a schematic diagram of a high plane position in a Z-axis direction provided in the embodiments of the present disclosure.

FIG. 6 is a schematic diagram of a node encoding sequence provided in the embodiments of the present disclosure.

FIG. 7A is a first schematic diagram of a planar flag information provided in the embodiments of the present disclosure.

FIG. 7B is a second schematic diagram of a planar flag information provided in the embodiments of the present disclosure.

FIG. 8 is a schematic diagram of sibling nodes of a current node provided in the embodiments of the present disclosure.

FIG. 9 is an intersection schematic diagram of a laser radar with a node provided in the embodiments of the present disclosure.

FIG. 10 is a schematic diagram of a neighborhood node at the same partitioning depth and the same coordinate.

FIG. 11A to FIG. 11C are schematic diagrams of a current node located at a low plane position of a parent node.

FIG. 12A to FIG. 12C are schematic diagrams of a current node located at a high plane position of a parent node.

FIG. 13 is a schematic diagram of predictive coding of plane position information of a laser radar point cloud.

FIG. 14 provides an encoding schematic diagram of infer direct coding model.

FIG. 15A is a schematic diagram of vertexes of a sub-block.

FIG. 15B is a schematic diagram of triangle patch fitting of a sub-block.

FIG. 15C is a schematic diagram of upsampling of a sub-block.

FIG. 16 illustrates a schematic diagram of a composition framework of a point cloud encoder.

FIG. 17 illustrates a schematic diagram of a composition framework of a point cloud decoder.

FIG. 18 illustrates a schematic flowchart of a decoding method provided in the embodiments of the present disclosure.

FIG. 19 illustrates a schematic flowchart of a decoding method provided in the embodiments of the present disclosure.

FIG. 20 illustrates a schematic flowchart of an encoding method provided in the embodiments of the present disclosure.

FIG. 21 is a schematic diagram of planar coding provided in the embodiments of the present disclosure.

FIG. 22 is a schematic diagram of reference nodes of a child node.

FIG. 23 is a schematic diagram of reference neighboring nodes of a current point.

FIG. 24 is a schematic diagram of adjacent blocks corresponding to a current block to be encoded.

FIG. 25 is a schematic diagram of a predictive tree.

FIG. 26 is a first schematic diagram of a composition structure of an encoder.

FIG. 27 is a second schematic diagram of a composition structure of an encoder.

FIG. 28 is a first schematic diagram of a composition structure of a decoder.

FIG. 29 is a second schematic diagram of a composition structure of a decoder.

### DETAILED DESCRIPTION

To provide a more detailed understanding of the features and technical content of the embodiments of the present disclosure, the implementations of the embodiments of the present disclosure will be described in detail below in conjunction with the accompanying drawings. The accompanying drawings are for reference and illustration only and not intended to limit the embodiments of the present disclosure.

Unless defined otherwise, all technical and scientific terms used herein have the same meaning as commonly understood by those skilled in the art belonging to technical field of the present disclosure. The terms used herein are for the purpose of describing the embodiments of the present disclosure only and not intended to limit the present disclosure.

In the following description, reference is made to “some embodiments”, which describe a subset of all possible embodiments. However, it is to be understood that “some embodiments” may be the same subset or different subsets of all possible embodiments and be combined with each other without conflict.

It should also be noted that the terms “first\second\third” involved in the embodiments of the present disclosure are merely used to distinguish similar objects and do not represent a specific order for the objects. It is to be understood that “first\second\third” may, where permitted, interchange their specific order or sequence, so that the embodiments of the present disclosure described here can be implemented in an order other than that illustrated or described here.

A point cloud is a three-dimensional representation form of a surface of an object. Point cloud (data) on the surface of the object may be collected through acquisition devices such as a photoelectric radar, a laser radar, a laser scanner or a multi-view camera.

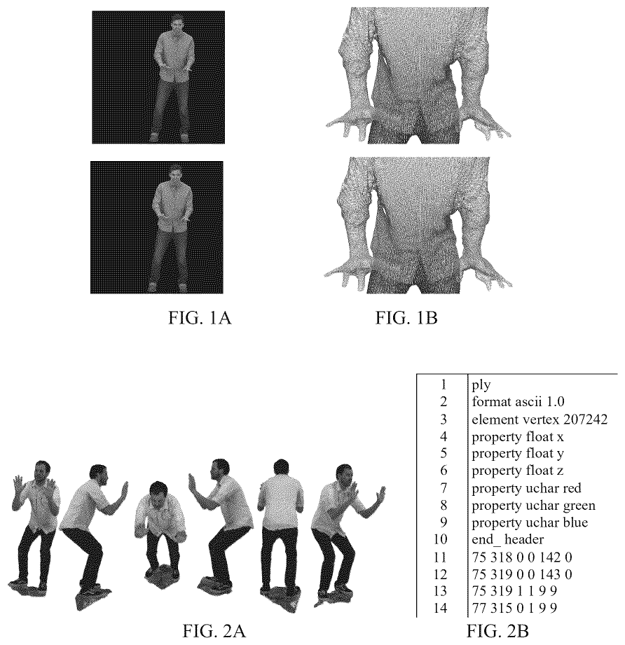

The point cloud is a set of discrete points in space that are irregularly distributed and express the spatial structure and surface attributes of a three-dimensional object or scenario. FIG. 1A illustrates a three-dimensional point cloud picture and FIG. 1B illustrates a partially enlarged view of a three-dimensional point cloud picture. It can be seen that the point cloud surface is composed of densely distributed points.

A two-dimensional picture has information expression at each pixel point, and the distribution is regular, so there is no need to record its position information additionally. However, the distribution of points in the point cloud is random and irregular in three-dimensional space, so it is necessary to record the position of each point in space to completely express the entire point cloud. Similar to the two-dimensional picture, during the acquisition process, each position has corresponding attribute information (RGB color values usually), and the color values reflect the color of the object. For the point cloud, in addition to color information, the attribute information corresponding to each point also commonly includes a reflectance value, and the reflectance value reflects the surface material of the object. Therefore, the point cloud data usually includes geometry information composed of three-dimensional position information and attribute information composed of three-dimensional color information and one-dimensional reflectance information. A point in the point cloud may include position information of the point and attribute information of the point. For example, the position information of the point may be three-dimensional coordinate information (x, y, z) of the point. The position information of the point may also be referred to as geometry information of the point. For example, the attribute information of the point may include color information (three-dimensional color information) and/or reflectance (one-dimensional reflectance information r), or the like. For example, the color information may be information in any color space. For example, the color information may be RGB information, where R represents red (R), G represents green (G) and B represents blue (B). For another example, the color information may be luma-chroma (YCbCr, YUV) information, where Y represents luminance (Luma), Cb (U) represents blue chromatic aberration and Cr (V) represents red chromatic aberration.

For a point cloud obtained according to the laser measurement principle, a point in the point cloud may include three-dimensional coordinate information of the point and a reflectance value of the point. For another example, a point cloud obtained according to the photogrammetry principle, a point in the point cloud may include three-dimensional coordinate information of the point and three-dimensional color information of the point. For another example, for a point cloud obtained by combining the laser measurement principle and photogrammetry principle, a point in the point cloud may include three-dimensional coordinate information of the point, a reflectance value of the point and three-dimensional color information of the point.

FIG. 2A and FIG. 2B illustrate a point cloud picture and its corresponding data storage format, respectively. FIG. 2A provides six viewing angles of the point cloud picture, and FIG. 2B consists of a file header information part and a data part. The header information includes a data format, a data representation type, the total number of points in the point cloud and content represented by the point cloud. For example, the point cloud is in “.ply” format, represented by ASCII code, and has a total of 207242 points. Each point has three-dimensional coordinate information (x, y, z) and three-dimensional color information (r, g, b).

Point clouds may be classified into following three types according to the ways of acquisition:
a static point cloud: that is, an object is static, and a device for acquiring the point cloud is also static;
a dynamic point cloud: an object is dynamic, but a device for acquiring the point cloud is static; and
a dynamically acquired point cloud: a device for acquiring the point cloud is dynamic.

For example, point clouds may be classified into two types according to purposes:
type I: a machine perception point cloud, which may be used for scenarios, such as, an autonomous navigation system, a real-time inspection system, a geographic information system, a visual sorting robot, and a disaster relief robot; and
type II: a human eye perception point cloud, which may be used for point cloud application scenarios, such as, digital cultural heritage, free viewpoint broadcasting, 3D immersive communication, and 3D immersive interaction.

The point cloud may express the spatial structures and surface attributes of three-dimensional objects or scenarios flexibly and conveniently; and since the point cloud is acquired by directly sampling real objects, the point cloud provides a strong sense of reality while ensuring accuracy. Therefore, the point cloud is widely applied, and its applied range includes a virtual reality game, a computer-aided design, a geographic information system, an automatic navigation system, digital cultural heritage, free viewpoint broadcasting, three-dimensional immersive remote presentation, and three-dimensional reconstruction of biological tissues and organs or the like.

The collection of the point cloud mainly includes the following ways: computer generation, 3D laser scanning, 3D photogrammetry or the like. The computer may generate point clouds of virtual three-dimensional objects and scenarios; 3D laser scanning may obtain point clouds of static real-world three-dimensional objects or scenarios, and may obtain millions of point clouds per second; and 3D photogrammetry may obtain point clouds of dynamic real-world three-dimensional objects or scenarios, and may obtain tens of millions of point clouds per second. These technologies reduce the cost and time period of point cloud data acquisition and improve the accuracy of data. The change in the way for acquiring point cloud data makes it possible to acquire a large amount of point cloud data. However, with the growth of application demand, the processing of massive 3D point cloud data has encountered the bottleneck in storage space and transmission bandwidth limitation.

For example, taking a point cloud video with a frame rate of 30 frames per second (fps) as an example, the number of points of the point cloud per frame is 700,000, and each point has coordinate information xyz (float) and color information RGB (uchar); and thus, the data volume of a 10 s point cloud video is approximately 0.7 million×(4 Byte×3+1 Byte×3)×30 fps×10 s=3.15 GB, where 1 Byte is 8 bit. For a two-dimensional video with a YUV sampling format of 4:2:0, a resolution of 1280×720 and a frame rate of 24 fps, the data volume of a 10 s video is approximately 1280×720×12 bit×24 fps×10 s≈0.33 GB, and the data volume of a 10 s three-dimensional video with two-viewpoints is approximately 0.33×2=0.66 GB. It can be seen that, for videos with the same length, the data volume of point cloud video is much larger than that of two-dimensional video or that of three-dimensional video. Therefore, in order to better realize data management, save server storage space and reduce the transmission traffic and transmission time between the server and the client, point cloud compression has become a key issue to promote the development of the point cloud industry.

That is, since the point cloud is a collection of massive points, storing the point cloud not only consumes a lot of memory, but also causes inconvenient for transmission; and there is no such large bandwidth to support direct transmission of the point cloud at the network layer without compression. Therefore, the point cloud needs to be compressed.

At present, a point cloud encoding framework that could perform compression on the point cloud may be a G-PCC encoding and decoding framework or a V-PCC encoding and decoding framework provided by the MPEG, or may be an audio video coding standard-PCC (AVS-PCC) encoding and decoding framework provided by the AVS. The G-PCC encoding and decoding framework may be used to perform compression on a first type of static point cloud and a third type of dynamically acquired point cloud, and the V-PCC encoding and decoding framework may be used to perform compression on a second type of dynamic point cloud. The G-PCC encoding and decoding framework is also referred to as a point cloud codec (encoder/decoder) TMC13, and the V-PCC encoding and decoding framework is also referred to as a point cloud codec TMC2.

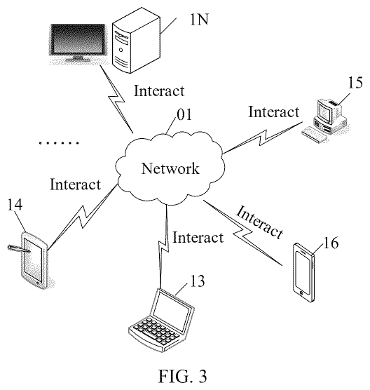

The embodiments of the present disclosure provide a network architecture of a point cloud encoding and decoding system including a decoding method and an encoding method. FIG. 3 is a schematic diagram of a network architecture of point cloud encoding and decoding provided in the embodiments of the present disclosure. As illustrated in FIG. 3, the network architecture includes one or more electronic devices 13 to IN and a communication network 01, where the electronic devices 13 to IN may perform video interaction through the communication network 01. During the implementation process, the electronic device may be various types of devices with point cloud encoding and decoding functions. For example, the electronic device may include a mobile phone, a tablet computer, a personal computer, a personal digital assistant, a navigator, a digital phone, a video phone, a television, a sensor device, a server, or the like, and the embodiments of the present disclosure are not limited thereto. The decoder or encoder in the embodiments of the present disclosure may be the above electronic device.

The electronic device in the embodiment of the present disclosure has point cloud encoding and decoding functions, and generally, the electronic device includes a point cloud encoder (i.e., encoder) and a point cloud decoder (i.e., decoder).

The point cloud compression technology will be described by taking the G-PCC encoding and decoding framework as an example below.

It is to be understood that in the point cloud G-PCC encoding and decoding framework, for the point cloud data to be encoded, the point cloud data is partitioned into multiple slices through slice partitioning firstly. In each slice, the geometry information of the point cloud and the attribute information corresponding to each point cloud are encoded separately.

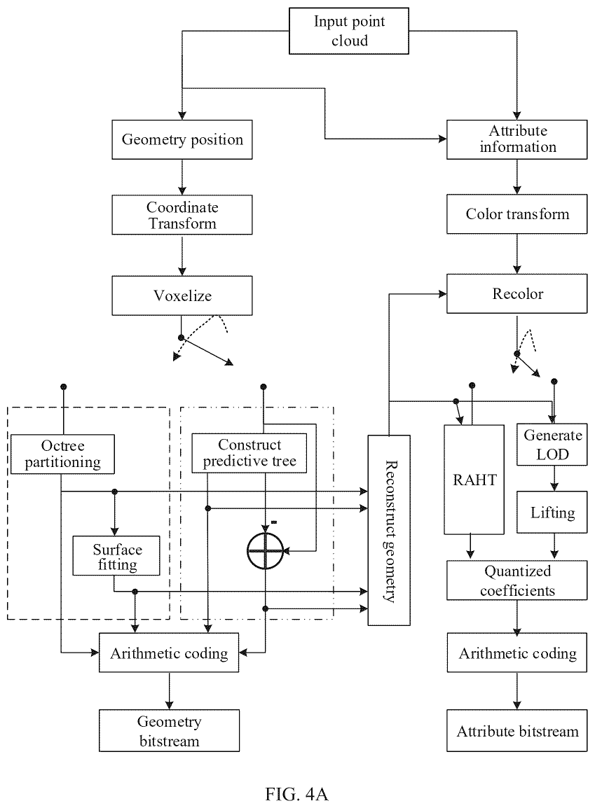

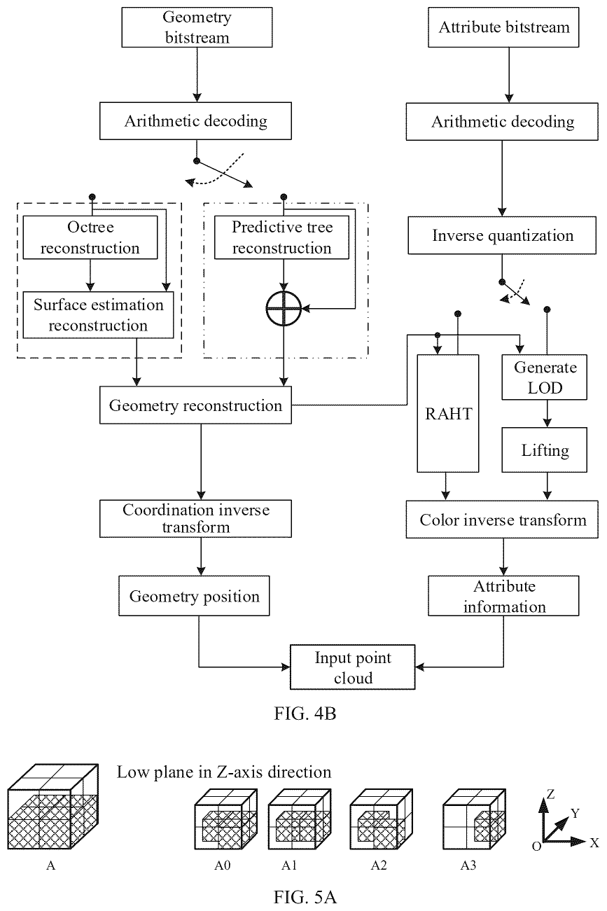

FIG. 4A illustrates a schematic diagram of a composition framework of a G-PCC encoder. As illustrated in FIG. 4A, during the geometry encoding process, coordinate transform is performed on the geometry information, so that all point clouds are included in a Bounding Box, and then, quantization is performed, where the process of quantization mainly plays the role of scaling. Due to quantization and rounding, the geometry information of part of the point clouds is the same, and it is determined whether to remove duplicate points based on parameters. The process of quantization and removal of duplicate points is also referred to as voxelization process. Then, octree partitioning or predictive tree construction is performed on the Bounding Box. During this process, arithmetic encoding is performed on points among the partitioned leaf nodes to generate a binary geometry bitstream; or arithmetic encoding is performed on vertexes generated by partitioning (surface fitting is performed based on the vertexes) to generate a binary geometry bitstream. During the attribute encoding process, after geometry encoding is completed and the geometry information is reconstructed, color transform is required firstly, to transform the color information (i.e., attribute information) from the RGB color space to the YUV color space. Then, recoloring is performed on the point cloud using the reconstructed geometry information, so that the unencoded attribute information is corresponded to the reconstructed geometry information. Attribute encoding is mainly performed for the color information. During the process of color information encoding, there are two main transform methods: one is the distance-based lifting transform that depends on level of detail (LOD) partitioning, and the other is the direct region adaptive hierarchical transform (RAHT). Both methods could transform the color information from the spatial domain to the frequency domain, and obtain high-frequency coefficients and low-frequency coefficients through transform. Finally quantization is performed on the coefficients, and next, arithmetic encoding is performed on the quantization coefficients to generate a binary attribute bitstream.

FIG. 4B illustrates a schematic diagram of a composition framework of a G-PCC decoder. As illustrated in FIG. 4B, for the acquired binary bitstream, the geometry and attribute bitstreams in the binary bitstream are first decoded independently. Upon decoding the geometry bitstream, the geometry information of the point cloud is obtained through arithmetic decoding, octree reconstruction/predictive tree reconstruction, geometry reconstruction and coordinate inverse conversion. Upon decoding the attribute bitstream, the attribute information of the point cloud is obtained through arithmetic decoding, inverse quantization, LOD partitioning/RAHT and color inverse conversion. The point cloud data to be encoded (i.e., output point cloud) is restored based on the geometry information and attribute information.

It is to be noted that, as illustrated in FIG. 4A or FIG. 4B, the current G-PCC geometry encoding and decoding may be divided into octree-based geometry encoding and decoding (marked by a dashed box) and predictive tree-based geometry encoding and decoding (marked by a dash-dotted line box).

For the octree-based geometry encoding (Octree geometry encoding, OctGeomEnc), the OctGeomEnc includes the following. First, coordinate transform is performed on the geometry information, so that all point clouds are included in a Bounding Box. Then, quantization is performed, and the process of quantization mainly plays the role of scaling. Due to quantization and rounding, the geometry information of part of points is the same, it is determined whether to remove duplicate points based on parameters, and the process of quantization and removal of duplicate points is also referred to as voxelization process. Next, tree partitioning (e.g., octree, quadtree, binary tree) is performed on the Bounding Box continually in the order of breadth-first traversal, and the occupancy code of each node is encoded. In related art, a company proposed an implicit geometry partitioning method. First, the bounding box of the point cloud (2\hat{ }(d_x), 2\hat{ }(d_y), 2\hat{ }(d_z)) is calculated; and assuming that d_x>d_y>d_z, the bounding box corresponds to a cuboid. During geometry partitioning, binary tree partitioning is performed first based on the x-axis to obtain two child nodes; binary tree partitioning continues until the condition of d_x=d_y>d_z is met, quadtree partitioning is performed continually based on the x and y axes to obtain four child nodes; and then, when the condition of d_x=d_y=d_z is met, octree partitioning is performed continually until the leaf node obtained through partitioning is a unit cube with a size of 1×1×1, at which the partitioning operation terminates. After that, the points in the leaf nodes are encoded to generate a binary bitstream. During the process of binary tree/quadtree/octree-based partitioning, two parameters, K and M, are introduced. Parameter K indicates the maximum number of binary tree/quadtree partitionings before octree partitioning is performed; and parameter M is used to indicate that the side length of the corresponding minimum block is 2\hat{ }M when binary tree/quadtree partitioning is performed. At the same time, K and M must meet the condition: assuming that d_max=max(d_x, d_y, d_z), d_min=min(d_x, d_y, d_z), parameter K meets the condition of K≥d_max−d_min; and parameter M meets the condition of M≥d_min. The reason why parameters K and M meet the above conditions is that, during the current process of G-PCC geometry implicit partitioning, the priority of the partitioning manners is binary tree, quadtree and octree. Only when the block size of the node does not meet the condition of binary tree/quadtree, octree partitioning will be performed on the node until the minimum unit of the partitioned leaf node has a size of 1×1×1. The octree-based geometry information encoding mode may effectively encode the geometry information of the point cloud by utilizing the correlation between adjacent points in space. However, for some relatively planar nodes or nodes with planar characteristics, the coding efficiency of the geometry information of point cloud may be further improved by utilizing the planar coding mode.

For example, FIG. 5A and FIG. 5B provide schematic diagrams of plane positions. FIG. 5A illustrates a schematic diagram of a low plane position in a Z-axis direction, and FIG. 5B illustrates a schematic diagram of a high plane position in the Z-axis direction. As illustrated in FIG. 5A, A, A0, A1, A2 and A3 here all belong to the low plane positions in the Z-axis direction. Taking A as an example, it can be seen that the four occupied child nodes of the current node are all located in the low plane positions of the current node in the Z-axis direction. Therefore, it may be considered that the current node belongs to the Z plane and is a low plane in the Z-axis direction. Similarly, as illustrated in FIG. 5B, B, B0, B1, B2 and B3 here all belong to the high plane positions in the Z-axis direction. Taking B as an example, it can be seen that the four occupied child nodes of the current node are located in the high plane positions of the current node in the Z-axis direction. Therefore, it may be considered that the current node belongs to the Z plane and is a high plane in the Z-axis direction.

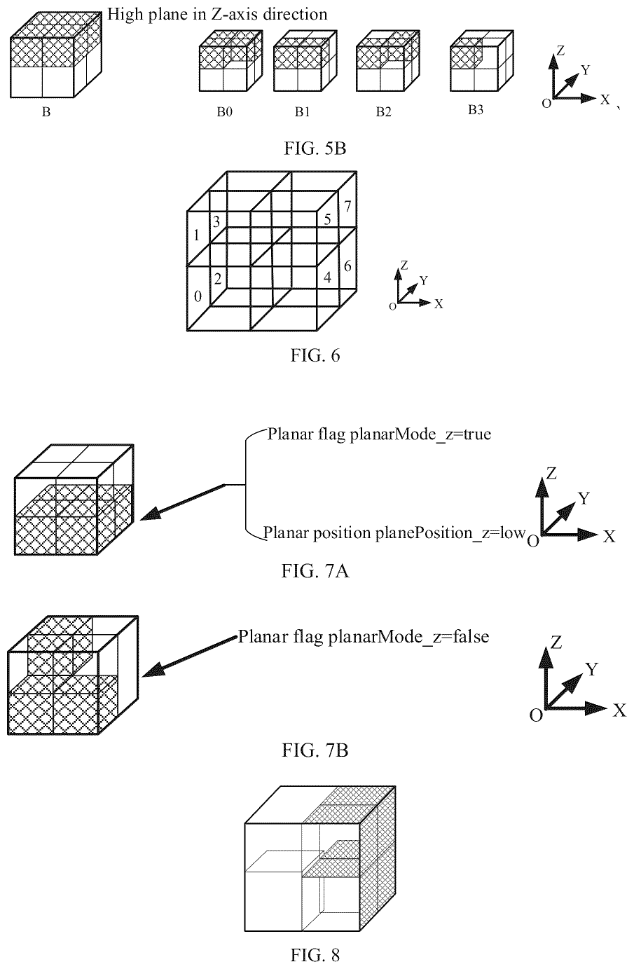

Further, the efficiency of octree coding and the efficiency of planar coding are compared. FIG. 6 provides a schematic diagram of a node encoding sequence, that is, encoding is performed on nodes according to the sequence of 0, 1, 2, 3, 4, 5, 6 and 7 illustrated in FIG. 6. Here, if the octree coding manner is adopted for A in FIG. 5A, the occupancy information of the current node is represented as: 11001100. However, if the planar coding manner is adopted, one identifier needs to be encoded first to represent that the current node is a plane in the Z-axis direction; secondly, if the current node is a plane in the Z-axis direction, the plane position of the current node needs to be represented; and thirdly, only the occupancy information of the low plane node in the Z-axis direction needs to be encoded (that is, the occupancy information of the four child nodes 0, 2, 4 and 6). Therefore, only 6 bits need to be encoded when encoding is performed on the current node based on the planar coding manner, which can reduce representation of 2 bits compared with the octree coding of the related technology. Based on the analysis, planar coding achieves a significant improvement in coding efficiency compared with octree coding. Therefore, for an occupied node, if the planar coding manner is adopted in a certain dimension, firstly, it is necessary to represent the planar flag (planarMode) and plane position (PlanePos) information of the current node in such dimension, and then, encode the occupancy information of the current node based on the plane information of the current node. For example, FIG. 7A illustrates a first schematic diagram of planar flag information. As illustrated in FIG. 7A, there is a low plane in the Z-axis direction; accordingly, the value of the planar flag information is true or 1, i.e., planarMode_Z=true; and the plane position information is low plane, i.e., PlanePosition_Z=low. FIG. 7B illustrates another second schematic diagram of planar flag information. As illustrated in FIG. 7B, there is no plane in the Z-axis direction; accordingly, the value of the planar flag information is false or 0, i.e., planarMode_Z=false.

It is to be noted that, for planarMode_i, 0 represents that the current node is not a plane in the i-axis direction, and I represents that the current node is a plane in the i-axis direction. If the current node is a plane in the i-axis direction, for PlanePosition_i, 0 represents that the current node is a low plane in the i-axis direction, and 1 represents that the current node is a high plane in the i-axis direction. Where i represents the coordinate dimension, which may be the X-axis direction, the Y-axis direction or the Z-axis direction, so i=0, 1, 2.

In the G-PCC standards, it is determined whether a node meets the condition for planar coding; and when the node meets the condition for planar coding, it is necessary to perform predictive coding on the planar flag and plane position information.

In the current G-PCC standards, there are three types of determination condition for determining whether a node meets planar coding, which are described in detail below.

I. The determination is performed according to the plane probability of the node in each dimension:
(1) local node density (local_node_density) of the current node is determined; and
(2) probability of the current node Prob(i) in each dimension is determined.

When the local_node_density of the node is less than a threshold Th (e.g., Th=3), the plane probabilities of the current node in three coordinate dimensions Prob(i) are compared with thresholds Th0, Th1 and Th2, where Th0<Th1<Th2 (e.g., Th0=0.6, Th1=0.77 and Th2=0.88). Here, Eligibleᵢ (i=0, 1, 2) is used to represent whether the planar coding is enabled in each dimension, Eligibleᵢ=Prob(i)>=threshold.

It is to be noted that the thresholds are adaptively changed. For example, when Prob(0)>Prob(1)>Prob(2), the setting of Eligible; is as follows:

$${Eligible}_{0} = Prob ( 0 ) > = Th 1 ; \\ {Eligible}_{1} = Prob ( 1 ) > = Th 0 ; \\ and \\ {Eligible}_{2} = Prob ( 2 ) > = Th 2.$$

When Prob(1)>Prob(0)>Prob(2), the setting of Eligible; is as follows:

$${Eligible}_{0} = Prob ( 0 ) > = Th 1 ; \\ {Eligible}_{1} = Prob ( 1 ) > = Th 0 ; \\ and \\ {Eligible}_{2} = Prob ( 2 ) > = T h 2 .$$

Here, Prob(i) is updated as follows:

$$Prob {( i )}_{new} = ( L \times Prob ( i ) + δ ( coded node ) ) / L + 1 \qquad ( 1 )$$

Where, L=255. In addition, if the coded node is a plane, δ(coded node) is 1; otherwise, δ(coded node) is 0.

Here, local_node_density is updated as follows:

$$local\_node {\_density}_{new} = local\_node \_density + 4 \times numSiblings \qquad ( 2 )$$

Where local_node_density is initialized to 4, and numSiblings is the number of sibling nodes of such node. For example, FIG. 8 is a schematic diagram of sibling nodes of a current node provided in the embodiments of the present disclosure. As illustrated in FIG. 8, the current node is a node filled with diagonal lines, the nodes filled with grids are sibling nodes, so the number of sibling nodes of the current node is 5 (including the current node itself).

II. It is determined whether the nodes in the current level (or referred to as layer) meet planar coding according to the point cloud density of the current level.

The density of points in the current level is used to determine whether to perform planar coding on the nodes in the current level. Assuming that the number of points in the current to-be-encoded point cloud is pointCount, and the number of points reconstructed after IDCM encoding is numPointCountRecon. Because octree coding is performed based on the order of breadth-first traversal, the number of nodes to be encoded in the current level is assumed to be nodeCount; and then the determination of whether planar coding is enabled on the current level is assumed to be planarEligibleKOctreeDepth. Specifically, planarEligibleK OctreeDepth=(pointCount−numPointCountRecon)<nodeCount×1.3.

If (pointCount-numPointCountRecon) is less than nodeCount×1.3, planarEligibleKOctreeDepth is true; and if (pointCount-numPointCountRecon) is not less than nodeCount×1.3, planarEligibleKOctreeDepth is false. In this way, when planarEligibleKOctreeDepth is true, planar coding is performed on all nodes in the current level; otherwise, planar coding is not performed on all nodes in the current level, and octree coding is adopted only.

III. It is determined whether the current node meets planar coding according to the acquisition parameters of the laser radar point cloud.

FIG. 9 is an intersection schematic diagram of a laser radar with a node provided in the embodiments of the present disclosure. As illustrated in FIG. 9, the node filled with grids is passed through by two lasers simultaneously, so the current node is not a plane in the Z axis vertical direction. The node filled with diagonal lines is sufficiently small such that the node cannot be passed through by two lasers simultaneously, so the node filled with diagonal lines may be a plane in the Z axis vertical direction.

Furthermore, for a node meeting the condition for planar coding, predictive coding may be performed on the planar flag information and the plane position information.

First, predictive coding is performed on the planar flag information.

Here, only three pieces of context information are adopted for coding, that is, context design for the planar flag in each coordinate dimension is performed separately.

Secondly, predictive coding is performed on the plane position information.

It is to be understood that, for coding of the plane position information of the non-laser radar point cloud, in the related art, the existing reference context information may include:
(a) the plane position information of the current node obtained by using the occupancy information of neighborhood nodes for prediction, the plane position information being three elements: predicted as low plane, predicted as high plane and unpredictable;
(b) the spatial distance between a node at the same partitioning depth and the same coordinate as the current node and the current node: “near” and “far”;
(c) if the node at the same partitioning depth and the same coordinate as the current node is a plane, the plane position of the node being determined; and
(d) coordinate dimension (i=0, 1, 2).

For example, FIG. 10 is a schematic diagram of a neighborhood node at the same partitioning depth and the same coordinate. As illustrated in FIG. 10, the current node is a small cube filled with grids; then, the neighborhood node (small cube filled with white) is searched under the same octree partitioning depth level and the same vertical coordinate, the distance between the two nodes is determined as “near” or “far”, and the plane position of the reference node is determined.

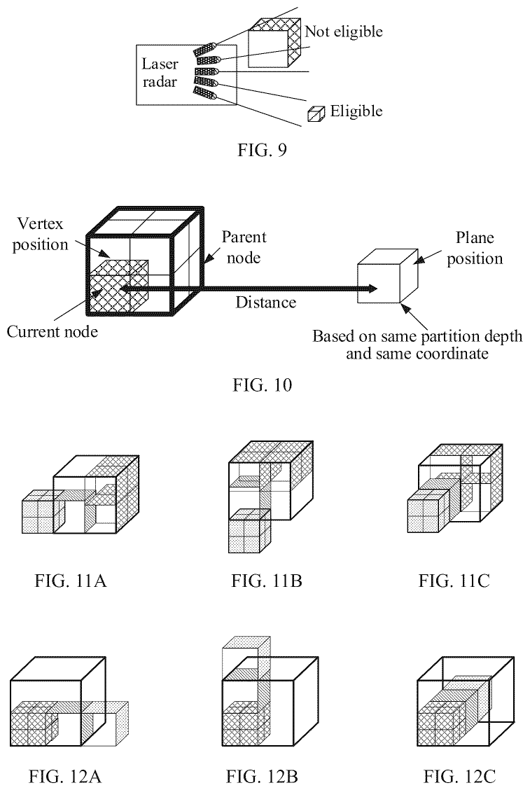

In the embodiments of the present disclosure, FIG. 11A to FIG. 11C are schematic diagrams of a current node located at a low plane position of a parent node. As illustrated in FIG. 11A to FIG. 11C, three examples in which the current node is located at the low plane position of the parent node are illustrated. The specific instructions are as follows.

I: If any one of child nodes 4 to 7 of a node filled with points is occupied, and all nodes filled with grids are not occupied, there is a high probability that there is a plane in the current node (filled with diagonal lines), and the plane position is located lower.

II: If none of the child nodes 4 to 7 of the node filled with points is occupied, and any node filled with grids are occupied, there is a high probability that there is a plane in the current node (filled with diagonal lines), and the plane position is located higher.

III: If all the child nodes 4 to 7 of the node filled with points are empty nodes, and all the nodes filled with grids are empty nodes, the plane position cannot be inferred and is therefore marked as unknown.

IV: If any one of the child nodes 4 to 7 of the node filled with points is occupied, and any one of the nodes filled with grids is occupied, the plane position still cannot be inferred and is therefore marked as unknown.

In the embodiments of the present disclosure, FIG. 12A to FIG. 12C are schematic diagrams of a current node located at a high plane position of a parent node. As illustrated in FIG. 12A to FIG. 12C, three examples in which the current node is located at the high plane position of the parent node are illustrated. The specific instructions are as follows.

I: If any one of child nodes 4 to 7 of a node filled with grids is occupied, and a node filled with points is not occupied, there is a high probability that there is a plane in the current node (filled with diagonal lines), and the plane position is located lower.

II: If the child nodes 4 to 7 of the node filled with grids are not occupied, and the node filled with points is occupied, there is a high probability that there is a plane in the current node (filled with diagonal lines), and the plane position is located higher.

III: If all the child nodes 4 to 7 of the node filled with grids are not occupied, and the node filled with points is not occupied, the plane position cannot be inferred and is therefore marked as unknown.

IV: If any one of the child nodes 4 to 7 of the node filled with grids is occupied, and the node filled with points is occupied, the plane position cannot be inferred and is therefore marked as unknown.

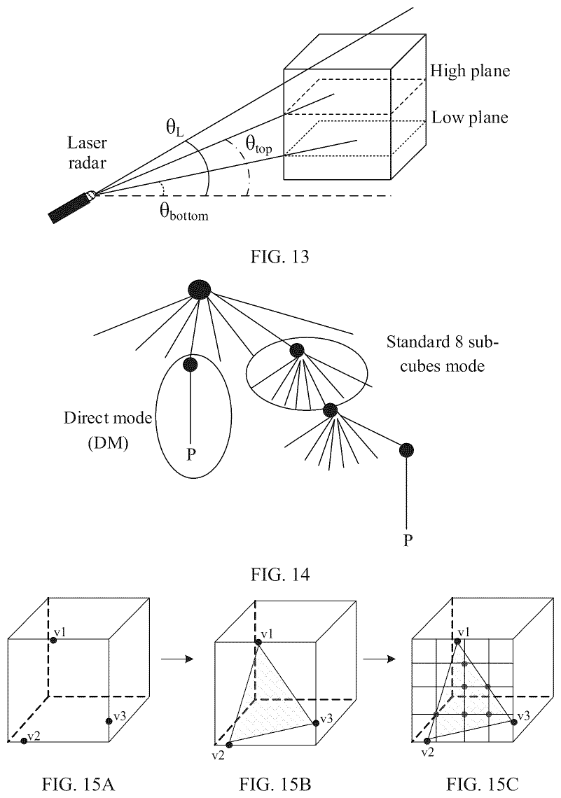

It is also to be understood that for coding of the plane position information of the laser radar point cloud, FIG. 13 is a schematic diagram of predictive coding of plane position information of a laser radar point cloud. As illustrated in FIG. 13, when the emission angle of the laser radar is θ_{bottom}, the node may be mapped as a bottom virtual plane; and when the emission angle of the laser radar is θₜₒₚ, the node may be mapped as a top virtual plane.

That is, the plane position of the current node is predicted by using the laser radar acquisition parameters, and the position is quantified into multiple intervals by using the position where the current node intersects with the laser ray, and finally serves as the context information of the plane position of the current node. The specific calculation process is as follows: assuming that the coordinates of the laser radar are (x_{Lidar}, y_{Lidar}, z_{Lidar}), and the geometric coordinates of the current node are (x, y, z), then a vertical tangent value tan θ of the current node relative to the laser radar is calculated firstly. The calculation formula is as follows:

$$tan θ = \frac{z - {z}_{Lidar}}{\sqrt{{( x - {x}_{Lidar} )}^{2} + {( y - {y}_{Lidar} )}^{2}}} \qquad ( 3 )$$

Further, since each Laser has a certain offset angle relative to the laser radar, it is further necessary to calculate a relative tangent value tan θ_{corr, L} of the current node relative to the Laser. The specific calculation is as follows:

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r} \qquad ( 4 )$$

Finally, prediction is performed on the plane position of the current node by using the relative tangent value tan θ_{corr, L} of the current node. Specifically, assuming that a tangent value of a lower boundary of the current node is tan (θ_{bottom}), and a tangent value of a top boundary is tan(θₜₒₚ), the plane position is quantized into 4 quantization intervals according to tan θ_{corr, L}, that is, the context information of the plane position is determined.

However, the octree-based geometry information coding mode has an efficient compression rate only for points with correlation in space, while for points in isolated positions in the geometry space, the complexity may be significantly reduced using the direct coding model (DCM). For all nodes in the octree, the use of DCM is not represented by flag bit information, but inferred through the parent node and neighbor information of the current node. There are three ways to determine whether the current node is eligible for DCM encoding, and details are as follows.

(1) The current node has no sibling child nodes, that is, the parent node of the current node has only one child node, and the parent node of the parent node of the current node has only two occupied child nodes, that is, the current node has one neighboring node at most.

(2) The parent node of the current node has only one occupied child node (i.e., the current node); and the six neighboring nodes that share a face with the current node also belong to empty nodes.

(3) The number of sibling nodes of the current node is greater than 1.

For example, FIG. 14 provides an encoding schematic diagram of infer direct coding mode (IDCM). If the current node is not eligible for DCM encoding, octree partitioning will be performed on the current node. If the current node is eligible for DCM encoding, the number of points included in the node will be further determined. When the number of points is less than a threshold (e.g., 2), DCM encoding will be performed on the node, otherwise, octree partitioning will continue to be performed on the node. When the DCM coding mode is applied, it is necessary to encode whether the current node is a real isolated point firstly, that is, IDCM_flag. When IDCM_flag is true, the current node adopts DCM encoding, otherwise, it is still adopts octree coding. When the current node meets the condition for DCM encoding, it is necessary to encode the DCM coding mode of the current node. At present, there are two DCM modes, which are: (a) existing only one point (or multiple points, but they are duplicate points); and (b) containing two points. Finally, it is necessary to encode the geometry information of each point. Assuming that a side length of the node is 2\hat{ }d, d bits are required to encode each component of the geometric coordinates of the node, and this bit information is directly encoded into the bitstream. It is to be noted here that when encoding is performed on the laser lidar point cloud, predictive coding is performed on the coordinate information with three dimensions by using the laser lidar acquisition parameters, thereby further improving the coding efficiency of the geometry information.

It is also to be noted that when a node is partitioned into leaf nodes, under geometry lossless encoding, the number of duplicate points in the leaf nodes needs to be encoded. Finally, the occupancy information of all nodes is encoded to generate a binary bitstream. In addition, a planar coding mode is introduced in G-PCC currently. During the process of geometry partitioning, it will be determined whether the child nodes of the current node are coplanar. If the child nodes of the current node meet the condition for coplanar, the child nodes of the current node will be represented by the plane.

For octree-based geometry decoding, before decoding the occupancy information of each node in the order of breadth-first traversal, the decoding side will first determine whether to perform planar decoding or IDCM decoding on the current node by using the reconstructed geometry information. If the current node meets the condition for planar decoding, the planar flag and plane position information of the current node will be decoded firstly, and then the occupancy information of the current node will be decoded based on the plane information. If the current node meets the condition for IDCM decoding, whether the current node is a true IDCM node will be decoded firstly. If it is a true IDCM node, the DCM decoding mode of the current node will continue to be parsed, then the number of points in the current DCM node may be obtained; and finally the geometry information of each point is decoded. For a node that does not meet the condition for either planar decoding or DCM decoding, the occupancy information of the current node will be decoded. By continuously parsing in this way, the occupancy code of each node is obtained, and the nodes are partitioned continuously in sequence until a unit cube with a size of 1×1×1 is obtained through partitioning, at which the partitioning operation terminates. The number of points included in each leaf node is obtained by parsing; and finally, the geometric reconstruction point cloud information is restored.

For triangle soup (trisoup)-based geometry information encoding, in the trisoup-based geometry information encoding framework, geometry partitioning may also be performed firstly. However, unlike binary tree/quadtree/octree-based geometry information encoding, this method does not need to partition the point cloud step by step into unit cubes with side lengths of 1×1×1, but partition the point cloud into sub-blocks until the side length of the sub-block is W. Based on the surface formed by the distribution of the point cloud in each block, at most 12 vertexes generated between the surface and the 12 edges of the block are obtained. The vertex coordinates of each block are encoded sequentially to generate a binary bitstream.

For trisoup-based point cloud geometry information reconstruction, when point cloud geometry information reconstruction is performed at the decoding side, the vertex coordinates are decoded firstly to complete triangle patch reconstruction, and the process is illustrated in FIG. 15A, FIG. 15B and FIG. 15C. There are 3 vertexes (v1, v2, v3) in the block illustrated in FIG. 15A. A triangle patch set formed by using these 3 vertexes in a certain order is called a triangle soup, or trisoup, as illustrated in FIG. 15B. Thereafter, sampling is performed on the trisoup, and the obtained sampling points are taken as the reconstructed point cloud within the block, as illustrated in FIG. 15C.

For predictive tree-based geometry encoding (Predictive geometry coding, PredGeom Tree), the PredGeom Tree includes the following. An input point cloud is sorted firstly, where the sorting manners currently adopted include disorder, Morton order, azimuth order and radial distance order. At the encoding side, the predictive tree structure is established by using two different manners, which include: KD-Tree (high delay slow mode) and low delay fast mode (laser radar calibration information utilization). When using the laser radar calibration information, each point is partitioned into different Lasers, and the predictive tree structure is constructed according to the different Lasers. Next, based on the predictive tree structure, each node in the predictive tree is traversed, prediction is performed on the geometry position information of the node by selecting different prediction modes to obtain the prediction residuals, and quantization is performed on the geometry prediction residuals using the quantization parameters. Finally, through continuous iteration, the prediction residuals of the predictive tree node position information, the predictive tree structure and the quantization parameters are encoded, to generate a binary bitstream.

For PredGeomTree, the decoding side reconstructs predictive tree structure by continuously parsing the bitstream, then obtains the quantization parameters and geometry position prediction residual information of each prediction node through parsing, performs inverse quantization on the prediction residuals to restore and obtain the reconstructed geometry position information of each node, and finally completes the geometric reconstruction at the decoding side.

After geometry encoding is completed, the geometry information needs to be reconstructed. At present, attribute encoding is mainly performed for color information. Firstly, the color information is transformed from the RGB color space to the YUV color space. Then, recoloring is performed on the point cloud using the reconstructed geometry information, so that the unencoded attribute information is corresponded to the reconstructed geometry information. During color information encoding, there are two main transform methods: one is the distance-based lifting transform that depends on LOD partitioning, and the other is the direct RAHT transform. Both methods could transform the color information from the spatial domain to the frequency domain, obtain high-frequency coefficients and low-frequency coefficients through transform, and finally perform quantization and encoding on the coefficients to generate a binary bitstream, as illustrated in FIG. 4A and FIG. 4B.

Further, when performing prediction on the attribute information using the geometry information, Morton codes may be used to perform nearest neighbor searching, and the Morton code corresponding to each point in the point cloud may be obtained from the geometric coordinates of the point. The specific method of calculating the Morton code is described as follows. For the three-dimensional coordinates whose each component is represented by a d-bits binary number, its three components may be expressed as:

$$x = {\sum }_{ℓ = 1}^{d} {2}^{d - ℓ} {x}_{ℓ} , y = {\sum }_{ℓ = 1}^{d} {2}^{d - ℓ} {y}_{ℓ} , z = {\sum }_{ℓ = 1}^{d} {2}^{d - ℓ} {z}_{ℓ} \qquad ( 5 )$$

Where [symbol] ∈{0, 1} are binary numerical values corresponding to the highest bit ( [symbol] =1) to the lowest bit ( [symbol] =d) of x, y and z. The Morton code M is generated by crosswise arranging [symbol] in sequence from the highest bit to the lowest bit of x, y and z. The calculation formula of M is as follows:

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}} \qquad ( 6 )$$

Where [symbol] ∈{0, 1} are values of M from the highest bit ( [symbol] ′=1) to the lowest bit ( [symbol] ′=3d). After the Morton code M of each point in the point cloud is obtained, the points in the point cloud are arranged in order of Morton code in an ascending order, and a weight value w of each point is set to 1.

It is also to be understood that for the G-PCC encoding and decoding framework, the general test conditions are as follows.

(1) There are 4 test conditions:
Condition 1: geometry positions with limited loss, and attributes with loss;
Condition 2: geometry positions lossless, but attributes with loss;
Condition 3: geometry positions lossless, and attributes with limited loss; and
Condition 4: geometry positions lossless, and attributes lossless.

(2) The general test sequence includes four categories: Cat1A, Cat1B, Cat3-fused and Cat3-frame. Cat3-frame point cloud only includes reflectance attribute information, Cat1A and Cat1B point clouds only include color attribute information, and Cat3-fused point cloud includes both color and reflectance attribute information.

(3) Technical routes: there are 2 technical routes in total, which are distinguished by the algorithm used for geometry compression.

### Technical Route 1: Octree Coding Branch

At the encoding side, the bounding box is partitioned into sub-cubes in sequence, and the non-empty (including points in the point cloud) sub-cubes continue to be partitioned until each leaf node obtained through partitioning is a unit cube with a size of 1×1×1. In the case of geometry lossless encoding, the number of points included in the leaf node needs to be encoded, and finally the geometry octree coding is completed to generate a binary bitstream.

At the decoding side, the decoding side obtains the occupancy code of each node by continuously parsing in the order of breadth-first traversal, and partitions the nodes continuously in sequence until a unit cube 1×1×1 is obtained, at which the partitioning operation terminates. In the case of geometry lossless decoding, it is necessary to parse and obtain the number of points included in each leaf node, and finally the geometric reconstruction point cloud information is restored.

### Technical Route 2: Predictive Tree Coding Branch

At the encoding side, the predictive tree structure is established by using two different ways, which include: KD-Tree (high delay slow mode)-based and laser radar calibration information utilization (low delay fast mode). Using the laser radar calibration information, each point may be partitioned into different Lasers, and the predictive tree structure may be constructed according to the different Lasers. Next, based on the predictive tree structure, each node in the predictive tree is traversed, prediction is performed on the geometry position information of the node by selecting different prediction modes to obtain the prediction residuals, and quantization is performed on the geometry prediction residuals using the quantization parameters. Finally, through continuous iteration, the prediction residuals of the predictive tree node position information, the predictive tree structure and the quantization parameters are encoded, to generate a binary bitstream.

At the decoding side, the decoding side reconstructs predictive tree structure by continuously parsing the bitstream, then obtains the quantization parameters and geometry position prediction residual information of each prediction node through parsing, performs inverse quantization on the prediction residuals to restore the reconstructed geometry position information of each node, and finally completes the geometric reconstruction at the decoding side.

It is to be seen that in the G-PCC codec, when the current node meets the condition for planar coding, whether to perform planar coding on nodes in each level is adaptively determined by utilizing the distribution density of the nodes in each level, without considering the geometric distribution characteristics of the point cloud in more detail, which results in low geometry coding efficiency of the point cloud.

The point cloud compression technology will be described by taking the AVS-PCC encoding and decoding framework as an example below.

In the point cloud AVS encoder framework, geometry information of a point cloud and attribute information corresponding to each point are encoded separately. Firstly, coordinate transform is performed on the geometry information, so that all point clouds are included in a bounding box. Before the pre-processing process, it is determined whether the entire point cloud sequence is partitioned into multiple point cloud slices according to parameter configurations, and each partitioned point cloud slice is regarded as a single independent point cloud serial processing. The pre-processing process includes quantization and removal of duplicate points. The process of quantization mainly plays the role of scaling. Due to quantization and rounding, the geometry information of some points is the same, and it is determined whether to remove the duplicate points based on parameters. Next, partitioning (octrees/quadtrees/binary trees) is performed on the bounding box in the order of breadth-first traversal, and encoding is performed on the occupancy code of each node. In the octree-based geometry encoding framework, the bounding box is partitioned into sub-cubes in sequence, and the non-empty (including points in the point cloud) sub-cubes continue to be partitioned until each leaf node obtained through partitioning is a unit cube with a size of 1×1×1, at which the partitioning operation terminates. Then, in the case of geometry lossless encoding, the number of points included in the leaf node is encoded, and finally the geometry octree coding is completed to generate a binary bitstream. In the octree-based geometry decoding process, the decoding side obtains the occupancy code of each node by continuously parsing in the order of breadth-first traversal, partitions the nodes continuously in sequence until a unit cube with a size of 1×1×1 is obtained, parses and obtains the number of points included in each leaf node, and finally restores the geometric reconstruction point cloud information.

There are two encoding manners in the current AVS geometry encoding, one is octree coding and the other is predictive tree encoding.

If the octree coding is adopted, there are two context coding models, in which context model 1 is used for cat1-A and cat2 point cloud sequences; and context model 2 is used for cat1-B and cat3 sequences.

It is to be understood that in the AVS-PCC encoding and decoding framework, point cloud compression generally adopts the manner of separately compressing geometry information and attribute information of a point cloud. At the encoding side, the geometry information of the point cloud is encoded firstly in the geometry encoder, and then the reconstructed geometry information is input into the attribute encoder as additional information to assist in the compression of point cloud attributes. At the decoding side, the geometry information of the point cloud is decoded firstly in the geometry decoder, and then the decoded geometry information is input into the attribute decoder as additional information to assist in the compression of point cloud attributes. The entire codec consists of three parts: pre-processing/post-processing, geometry encoding/decoding, and attribute encoding/decoding.

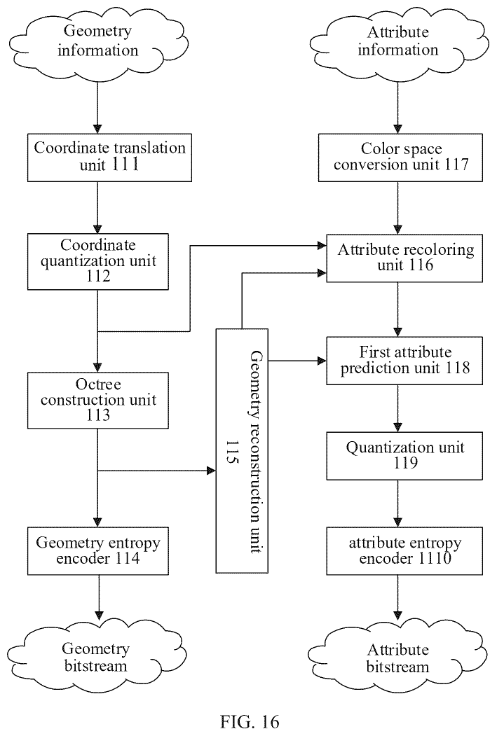

The embodiments of the present disclosure provide a point cloud encoder. FIG. 16 illustrates a framework of a point cloud compression reference platform PCRM provided by AVS. The point cloud encoder 11 includes a geometry encoder, which includes a coordinate translation unit 111, a coordinate quantization unit 112, an octree construction unit 113, a geometry entropy encoder 114, and a geometry reconstruction unit 115; and an attribute encoder, which includes an attribute recoloring unit 116, a color space transform unit 117, a first attribute prediction unit 118, a quantization unit 119 and an attribute entropy encoder 1110.

For PCRM, in the geometry encoding part of the encoding side, the original geometry information is pre-processed firstly. The geometry origin is normalized to the minimum position in the point cloud space through the coordinate translation unit 111, and the geometry information is converted from floating-point numbers to integers through the coordinate quantization unit 112, to facilitate subsequent regularization processing. Then, geometry encoding is performed on the regularized geometry information. The octree construction unit 113 performs recursive partitioning on the point cloud space using an octree structure, where in each partitioning, the current node is partitioned into eight equal-sized sub-blocks, and the occupancy code status of each sub-block is determined. When the sub-block does not include a point, the sub-block is marked as empty, otherwise the sub-block is marked as non-empty. The occupancy code information of all blocks is recorded at the last level of recursive partitioning, and geometry encoding is performed on the occupancy code information. On the one hand, the geometry information expressed by the octree structure is input into the geometry entropy encoder 114 to form a geometry bitstream; on the other hand, geometric reconstruction processing is performed on the geometry information through the geometry reconstruction unit 115, and the reconstructed geometry information is input into the attribute encoder as additional information.

In the attribute encoding part, the original attribute information is pre-processed firstly. Due to changes in the geometry information after geometry encoding, the attribute recoloring unit 116 reallocates attribute values to each point obtained after geometry encoding, to achieve attribute recoloring. In addition, if the processed attribute information is color information, it is necessary to transform the original color information into the YUV color space, which better matches visual characteristics of the human eye, by color space transform through the color space transform unit 117. Then, attribute encoding is performed on the pre-processed attribute information through the first attribute prediction unit 118, where in attribute encoding, the point clouds need to be reordered firstly, the manner of reordering is Morton code, so the traversal order for attribute encoding is Morton order. The attribute prediction method in PCRM is a Morton order-based single-point prediction, that is, tracing back one point from the current point to be encoded (current node) according to Morton order, the found node is the prediction reference point of the current point to be encoded, and then the attribute reconstruction value of the prediction reference point is used as the attribute prediction value, where the attribute residual value is the difference between the attribute original value and the attribute prediction value of the current point to be encoded. Finally, quantization is performed on the attribute residual value through the quantization unit 119, and the quantized residual information is input into the attribute entropy encoder 1110 to form an attribute bitstream.

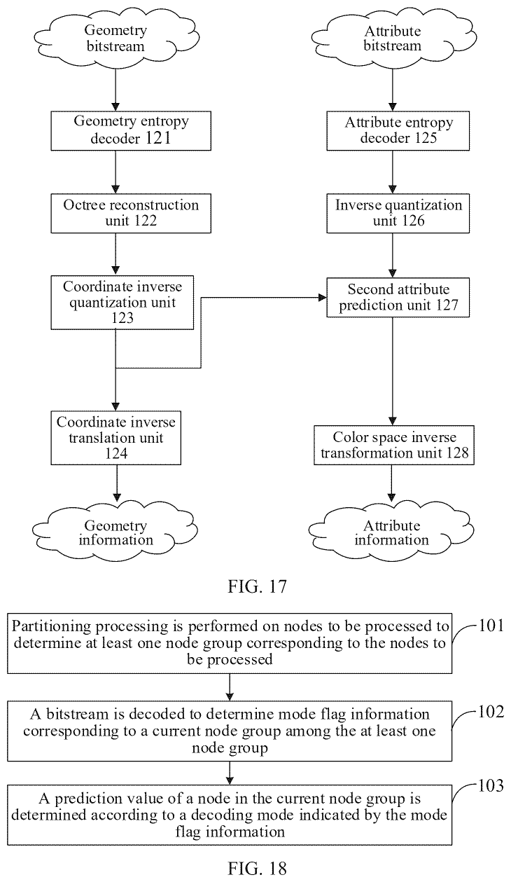

The embodiments of the present disclosure further provide a point cloud decoder. FIG. 17 illustrates a framework of a point cloud compression reference platform PCRM provided by AVS. The point cloud decoder 12 includes a geometry decoder, which includes a geometry entropy decoder 121, an octree reconstruction unit 122, a coordinate inverse quantization unit 123 and a coordinate inverse translation unit 124; and an attribute decoder, which includes an attribute entropy decoder 125, an inverse quantization unit 126, a second attribute prediction unit 127 and a color space inverse transform unit 128.

At the decoding side, the manner of separately decoding geometry and attributes is also adopted. In the geometry decoding part, firstly, entropy decoding is performed on the geometry bitstream through the geometry entropy decoder 121, to obtain the geometry information of each node, and then, the octree structure is constructed in the same way as geometry encoding through the octree reconstruction unit 122. Combining the coordinate-transformed geometry information, expressed by the octree structure and reconstructed through decoding, on the one hand, coordinate inverse quantization is performed on this information through the coordinate inverse quantization unit 123 and inverse translation is performed on this information through the coordinate inverse translation unit 124, to obtain the decoded geometry information, on the other hand, this information is input into the attribute decoder as additional information. In the attribute decoding part, Morton order is constructed in the same way as the encoding side. Firstly, entropy decoding is performed on the attribute bitstream through the attribute entropy decoder 125, to obtain the quantized residual information; then, inverse quantization is performed on the quantized residual information through the inverse quantization unit 126, to obtain the attribute residual value. Similarly, in the same way as attribute encoding, the attribute prediction value of the current point to be decoded is obtained through the second attribute prediction unit 127, and then the attribute prediction value is added to the attribute residual value, to restore the attribute reconstruction value (e.g., YUV attribute value) of the current point to be decoded. Finally, the decoded attribute information is obtained by color space inverse transform through the color space inverse transform unit 128.

It is also to be understood that the AVS-PCC encoding and decoding framework may be divided into Pred-based, based on Predtrans-resource limited, based on Predtrans-resource unlimited, and Trans-based.

There are 4 general test conditions, exemplarily, which may include:
Condition 1: geometry positions with limited loss, and attributes with loss;
Condition 2: geometry positions lossless, but attributes with loss;
Condition 3: geometry positions lossless, and attributes with limited loss; and
Condition 4: geometry positions lossless, and attributes lossless.

The general test sequence includes five categories: Cat1A, Cat1B, Cat1C, Cat2-frame and Cat3. Cat1A and Cat2-frame point clouds only include reflectance attribute information, Cat1B and Cat3 point clouds only include color attribute information, and Cat1C point cloud includes both color and reflectance attribute information.

There are four technical routes, which are distinguished by the algorithm used for attribute compression.

Technical route 1: Pred (prediction) branch, attribute compression adopts a method based on intra prediction.

At the encoding side, the points in the point cloud are processed according to a certain order (original acquisition order of the point cloud, Morton order, Hilbert order or the like). Firstly, a prediction algorithm is adopted to obtain attribute prediction values, and attribute residuals are obtained according to attribute values and the attribute prediction values. Then, quantization is performed on the attribute residuals to generate the quantized residuals. Finally, encoding is performed on the quantized residuals.

At the decoding side, the points in the point cloud are processed according to a certain order (original acquisition order of the point cloud, Morton order, Hilbert order or the like). Firstly, a prediction algorithm is adopted to obtain attribute prediction values, and next, the quantized residuals are obtained by decoding. Then, inverse quantization is performed on the quantized residuals. Finally, attribute reconstruction values are obtained based on the attribute prediction values and residuals obtained after inverse quantization.

Technical route 2: based on Predtrans-resource limited (based on prediction transform branch-resource limited), attribute compression adopts a method based on intra prediction and k-ary discrete cosine transform (DCT). When quantized transform coefficients are encoded, there is a limit on the maximum number of points, X (e.g., 4096), that is, at most every X points are grouped for encoding.

At the encoding side, the points in the point cloud are processed according to a certain order (original acquisition order of the point cloud, Morton order, Hilbert order or the like). Firstly, the entire point cloud is partitioned into several small groups with a maximum length of Y (e.g., 2), and next, these small groups are combined into several large groups (the number of points in each large group does not exceed X, e.g., 4096). Then, a prediction algorithm is adopted to obtain attribute prediction values, attribute residuals are obtained according to attribute values and the attribute prediction values, and DCT transform is performed on the attribute residuals on a small group basis to generate transform coefficients. Then, quantization is performed on the transform coefficients to generate quantized transform coefficients. Finally, the quantized transform coefficients are encoded on a large group basis.

At the decoding side, the points in the point cloud are processed according to a certain order (original acquisition order of the point cloud, Morton order, Hilbert order or the like). Firstly, the entire point cloud is partitioned into several small groups with a maximum length of Y (e.g., 2), and next, these small groups are combined into several large groups (the number of points in each large group does not exceed X, e.g., 4096). Quantized transform coefficients are obtained by decoding on a large group basis, and then a prediction algorithm is adopted to obtain attribute prediction values. Then, inverse quantization and inverse transform are performed on the quantized transform coefficients on a small group basis. Finally, attribute reconstruction values are obtained based on the attribute prediction values and coefficients obtained after inverse quantization and inverse transform.

Technical route 3: based on Predtrans-resource unlimited (based on prediction transform branch-resource unlimited), attribute compression adopts a method based on intra prediction and DCT transform. When quantized transform coefficients are encoded, there is no limit on the maximum number of points, X, that is, all coefficients are encoded together.

At the encoding side, the points in the point cloud are processed according to a certain order (original acquisition order of the point cloud, Morton order, Hilbert order or the like). Firstly, the entire point cloud is partitioned into several small groups with a maximum length of Y (e.g., 2), and next, a prediction algorithm is adopted to obtain attribute prediction values, and attribute residuals are obtained according to attribute values and the attribute prediction values. DCT transform is performed on the attribute residuals on a small group basis to generate transform coefficients. Then, quantization is performed on the transform coefficients to generate quantized transform coefficients. Finally, the quantized transform coefficients of the entire point cloud are encoded.

At the decoding side, the points in the point cloud are processed according to a certain order (original acquisition order of the point cloud, Morton order, Hilbert order or the like). Firstly, the entire point cloud is partitioned into several small groups with a maximum length of Y (e.g., 2), and quantized transform coefficients of the entire point cloud are obtained by decoding. Next, a prediction algorithm is adopted to obtain attribute prediction values. Then, inverse quantization and inverse transform are performed on the quantized transform coefficients on a small group basis. Finally, attribute reconstruction values are obtained based on the attribute prediction values and coefficients obtained after inverse quantization and inverse transform.

Technical route 4: Trans-based branch (multi-layer transform branch), attribute compression adopts a method based on multi-layer wavelet transform.

At the encoding side, multi-layer wavelet transform is performed on the entire point cloud to generate transform coefficients. Then, quantization is performed on the transform coefficients to generate quantized transform coefficients. Finally, encoding is performed on the quantized transform coefficients of the entire point cloud.

At the decoding side, quantized transform coefficients of the entire point cloud are obtained by decoding. Then, inverse quantization and inverse transform are performed on the quantized transform coefficients to obtain attribute reconstruction values.

In technical route 1, the coefficients may be the quantized residuals, and in the above technical routes 2, 3 and 4, the coefficients may be the quantized transform coefficients.

It is to be seen that in the current AVS-PCC codec, it is merely adaptively determined whether the point cloud adopts the context coding model I or context coding model II by utilizing the point cloud density at the encoding side, without considering the spatial distribution characteristics of the point cloud itself.

In order to solve the above problems, the embodiments of the present disclosure provide an encoding and decoding method. At the encoding side, partitioning processing is performed on nodes to be processed to determine at least one node group corresponding to the nodes to be processed; a coding mode corresponding to a current node group among the at least one node group is determined; a prediction value of a node in the current node group is determined according to the coding mode, and mode flag information corresponding to the current node group is determined according to the coding mode and signalled into a bitstream. At the decoding side, partitioning processing is performed on nodes to be processed to determine at least one node group corresponding to the nodes to be processed; a bitstream is decoded to determine mode flag information corresponding to a current node group among the at least one node group; and a prediction value of a node in the current node group is determined according to a decoding mode indicated by the mode flag information. In this way, by partitioning the nodes to be processed into different node groups, and then for each different node group, the coding mode suitable for the node group may be selected, so that encoding is performed based on the coding mode suitable for the node group, thereby effectively improving the geometry coding efficiency of the point cloud, and then improving the encoding and decoding performance of the point cloud.

The embodiments of the present disclosure will be described in detail below with reference to the accompanying drawings.

In an embodiment of the present disclosure, referring to FIG. 18, a flowchart of a decoding method provided in the embodiments of the present disclosure is illustrated. As illustrated in FIG. 18, the method may include the following.

Step 101: partitioning processing is performed on nodes to be processed to determine at least one node group corresponding to the nodes to be processed.

In the embodiments of the present disclosure, partitioning processing may be performed on the nodes to be processed first, to determine the at least one node group corresponding to the nodes to be processed.

It is to be noted that the decoding method in the embodiments of the present disclosure specifically refers to a point cloud decoding method, which may be applied to a point cloud decoder (also referred to as a “decoder” for short).

It is to be noted that, in the embodiments of the present disclosure, a point cloud to be processed includes multiple nodes to be processed. The nodes to be processed in the point cloud to be processed may be taken as the nodes to be decoded in the point cloud to be processed when decoding is performed on the nodes to be processed.

Further, in the embodiments of the present disclosure, each node to be processed in the point cloud to be processed corresponds to one piece of geometry information and one piece of attribute information; where the geometry information represents a spatial relationship of the point, and the attribute information represents relevant information of the attribute of the point.

Here, the attribute information may be color information, or may be reflectance or other attributes, which is not specifically limited in the embodiments of the present disclosure. When the attribute information is color information, which may specifically be color information in any color space. For example, the attribute information may be color information in the RGB space, color information in the YUV space, color information in the YCbCr space, or the like, which is not limited in the embodiments of the present disclosure.

It is to be noted that in the embodiments of the present disclosure, in the octree decoding process, the nodes to be processed may be part or all of nodes in one of levels to be decoded, or part or all of nodes in part of the levels to be decoded, or part or all of nodes in all levels to be decoded.

For example, in the embodiments of the present disclosure, in the octree decoding process, all nodes in the second decoding level of the octree may be taken as the nodes to be processed; or part of nodes in the second decoding level of the octree (for example, four nodes thereof) may be taken as the nodes to be processed.

For example, in the embodiments of the present disclosure, in the octree decoding process, the octree has a total of ten decoding levels, and all nodes in the second, third and fourth levels may be taken as the nodes to be processed; or part of nodes in the second, third and fourth levels may be taken as the nodes to be processed. For example, the nodes to be processed may include all nodes in the second level, part of nodes in the third level, and part of nodes in the fourth level.

For example, in the embodiments of the present disclosure, in the octree decoding process, there are eight nodes in the i-th level, and there are sixty-four nodes in the (i+1)-th level; where i is an integer greater than 0. The nodes to be processed may include four nodes in the i-th level and thirty-two nodes in the (i+1)-th level.

For example, in the embodiments of the present disclosure, in the octree decoding process, the octree has a total of ten decoding levels, and all nodes in the ten decoding levels may be taken as the nodes to be processed; or part of the nodes in the ten decoding levels may be taken as the nodes to be processed. For example, the nodes to be processed may include half of the nodes in each level of the ten decoding levels.

Further, in the embodiments of the present disclosure, the nodes to be processed may be partitioned to obtain the at least one node group.

For example, in the embodiments of the present disclosure, in the octree decoding process, the nodes to be processed are all nodes in the i-th and (i+1)-th levels, and partitioning processing may be performed on all the nodes in the i-th and (i+1)-th levels, to obtain the at least one node group.

For example, in the embodiments of the present disclosure, in the octree decoding process, there are eight nodes in the i-th level, there are sixty-four nodes in the (i+1)-th level, the nodes to be processed include four nodes in the i-th level and thirty-two nodes in the (i+1)-th level, and partitioning processing may be performed on the four nodes in the i-th level and thirty-two nodes in the (i+1)-th level, to obtain the at least one node group.

For example, in the embodiments of the present disclosure, in the octree decoding process, the nodes to be processed are part of nodes in the i-th level, and partitioning processing is performed on the part of nodes in the i-th level nodes, to obtain the at least one node group.

For example, in the embodiments of the present disclosure, in the octree decoding process, the octree has a total of ten decoding level, and the nodes to be processed are all nodes in these ten decoding levels, and partitioning processing may be performed on all the nodes in these ten decoding levels, to obtain the at least one node group.

In some embodiments, nodes in one level obtained after octree partitioning may be determined as one node group.

For example, in the embodiments of the present disclosure, in the octree decoding process, nodes in the i-th level may be partitioned into one node group.

For example, in the embodiments of the present disclosure, in the octree decoding process, nodes in the i-th level may be partitioned into one node group, and nodes in the (i+1)-th level may be partitioned into one node group.

In some embodiments, nodes in multiple levels obtained after octree partitioning may also be determined as one node group.

For example, in the embodiments of the present disclosure, in the octree decoding process, all nodes in the i-th and (i+1)-th levels are partitioned into one node group.

For example, in the embodiments of the present disclosure, in the octree decoding process, part of nodes in the i-th level and part of nodes in the (i+1)-th level may be partitioned into one node group.

In some embodiments, nodes in one level obtained after octree partitioning may be determined as multiple node groups.

For example, in the embodiments of the present disclosure, in the octree decoding process, the nodes in the i-th level may be partitioned into four node groups, and each node group includes four nodes.

For example, in the embodiments of the present disclosure, in the octree decoding process, nodes in the (i+2)-th level may be partitioned into three node groups, where both node groups 1 and 2 include eight nodes, and node group 3 includes four nodes.

For example, in the embodiments of the present disclosure, in the octree decoding process, the nodes in the i-th level may be partitioned into four node groups, and each node group includes four nodes. Accordingly, the nodes in the (i+1)-th level may be partitioned into four node groups, and each node group includes eight nodes.

For example, in the embodiments of the present disclosure, in the octree decoding process, the nodes in the i-th level may be partitioned into four node groups, where three node groups include eight nodes and one node group includes four nodes. Accordingly, the nodes in the (i+1)-th level may be partitioned into four node groups, and each node group includes eight nodes.

It is to be noted that in the embodiments of the present disclosure, when partitioning processing is performed on the nodes to be processed, the number of nodes in the node group may be limited by a preset threshold; that is, the number of nodes in each different node group among the at least one node group is less than or equal to the preset threshold.

For example, in the embodiments of the present disclosure, the nodes to be decoded (the nodes to be processed) in the current level are partitioned to obtain different Groups (node groups), where the number of nodes in each Group is N (N=1024), and the preset threshold is 1024, that is, among these Groups, the number of nodes in each Group is equal to the preset threshold.

For example, in the embodiments of the present disclosure, the preset threshold is 10, and point partitioning processing is performed on the nodes in the i-th level according to the preset threshold to obtain four node groups, where node group 1 includes eight nodes, node group 2 includes eight nodes, node group 3 includes four nodes, and node group 4 includes four nodes, that is, the number of nodes in each node group is less than the preset threshold.

For example, in the embodiments of the present disclosure, the preset threshold is 10, and partitioning processing is performed on the nodes in the third level of the octree according to the preset threshold to obtain three node groups, where node group 1 includes ten nodes, node group 2 includes eight nodes, and node group 3 includes four nodes, that is, the number of nodes in node group 1 is equal to the preset threshold, and the number of nodes in node group 2 and the number of node in node group 3 are less than the preset threshold.

For example, in the embodiments of the present disclosure, assuming that the number of nodes in the current level to be decoded is nodeCount, the maximum length (preset threshold) of the initialized Group is nodeCount.

Further, in the embodiments of the present disclosure, among the at least one node group obtained after partitioning processing is performed on the nodes to be processed, the numbers of nodes in different node groups are not all identical.

For example, in the embodiments of the present disclosure, point partitioning processing is performed on the nodes in the i-th level, to obtain three node groups, where node group 1 includes eight nodes, node group 2 includes eight nodes, and node group 3 includes four nodes. That is, the number of nodes in node group 1 is the same as that in node group 2, and the number of nodes in node group 3 is different from that in node group 1 and different from that in node group 2.

In some embodiments, adaptive partitioning processing may further be performed on the nodes to be processed according to a rate distortion optimization algorithm, to determine the at least one node group.

For example, in the embodiments of the present disclosure, the nodes to be processed are nodes in all decoding levels of octree, including nodes in twenty decoding levels. Adaptive partitioning processing is performed on all the nodes in these twenty decoding levels according to the rate distortion optimization algorithm, to obtain thirty-two node groups.

For example, in the embodiments of the present disclosure, the nodes to be processed are nodes in three decoding levels of octree, and adaptive partitioning processing is performed on the nodes in the three decoding levels according to the rate distortion optimization algorithm, to obtain three node groups.

For example, in the embodiments of the present disclosure, the nodes to be processed are all nodes in the first level, part of nodes in the second level and part of nodes in the third level of octree. Adaptive partitioning processing is performed on all the nodes in the first level, part of nodes in the second level and part of nodes in the third level according to the rate distortion optimization algorithm, to obtain ten node groups.

Further, in the embodiments of the present disclosure, the number of nodes may further be determined based on length information of a current node group among the at least one node group.

For example, in the embodiments of the present disclosure, the length information of the current node group is eight nodes, meaning that the current node group includes eight nodes.

Step 102: a bitstream is decoded to determine mode flag information corresponding to a current node group among the at least one node group.

In the embodiments of the present disclosure, after performing partitioning processing on the nodes to be processed to determine the at least one node group corresponding to the nodes to be processed, the bitstream may be decoded to determine the mode flag information corresponding to the current node group among the at least one node group.

It is to be noted that in the embodiments of the present disclosure, in response to a value of the mode flag information being a first value, it is determined that the decoding mode indicated by the mode flag information is octree decoding. In response to a value of the mode flag information being a second value, it is determined that the decoding mode indicated by the mode flag information is planar decoding.

It is to be noted that, in the embodiments of the present disclosure, the first and second values are used to indicate specific encoding and decoding modes in the G-PCC encoding and decoding framework, respectively.

In some embodiments, for the G-PCC encoding and decoding framework, when the value of the mode flag information is the first value, it indicates that the decoding mode is the octree decoding; or when the value of the mode flag information is the second value, it indicates that the decoding mode is the planar decoding.

Further, in the embodiments of the present disclosure, the specific numerical values of the first and second values are not limited by the present disclosure. For example, the first value may be 0, and the second value may be 1.

For example, in the embodiments of the present disclosure, the nodes to be decoded in the current level are partitioned, to obtain different Groups, where the number of nodes in each Group is N (N=1024), which is consistent with the encoding side. Then, before decoding the geometry information of each Group, the decoding mode codeMode of the current Group is decoded first. If the codeMode of the current Group is 0, octree decoding is adopted; otherwise, planar decoding is adopted. The details are as follows:

```
codeMode=decodeCodeMode( );
if(codeMode)
for(int nodeIdx=0;nodeIdx< N;++nodeIdx)
  PlanarDecoding(node[nodeIdx]);
else
for(int nodeIdx=0;nodeIdx< N;++nodeIdx)
  octreeDecoding(node[nodeIdx]);
```

Further, in the embodiments of the present disclosure, in response to the decoding mode indicated by the mode flag information being the octree decoding, geometry information for each node in the current node group is decoded using octree decoding. In response to the decoding mode indicated by the mode flag information being the planar decoding, geometry information for each node in the current node group is decoded using planar decoding.

It is to be noted that in the embodiments of the present disclosure, in response to a value of the mode flag information being a third value, it is determined that the decoding mode indicated by the mode flag information is first context decoding. In response to a value of the mode flag information is a fourth value, it is determined that the decoding mode indicated by the mode flag information is second context decoding.

It is to be noted that, in the embodiments of the present disclosure, the third and fourth values are used to indicate specific encoding and decoding modes in the AVS-PCC encoding and decoding framework, respectively.

In some embodiments, for the AVS-PCC encoding and decoding framework, when the value of the mode flag information is the third value, it indicates that the decoding mode is the first context decoding; or when the value of the mode flag information is the fourth value, it indicates that the decoding mode is the second context decoding.

It is to be noted that, in the embodiments of the present disclosure, the first context decoding refers to decoding performed using the context coding model one, and the second context decoding refers to decoding performed using the context coding model two.

Further, in the embodiments of the present disclosure, the specific numerical values of the third and fourth values are not limited by the present disclosure. For example, the third value may be 0, and the fourth value may be 1.

For example, in the embodiments of the present disclosure, the nodes to be decoded in the current level are partitioned, to obtain different Groups (node groups), where the number of nodes in each Group is N (N=1024). Then, before decoding the geometry information of each Group, the decoding mode codeMode (mode flag information) of the current Group is decoded first. If the codeMode of the current Group is 0, the context coding model 1 is adopted for decoding; otherwise, the context coding model 2 is used for decoding. The details are as follows:

```
codeMode=decodeCodeMode( );
if(codeMode)
for(int nodeIdx=0;nodeIdx< N;++nodeIdx)
  DecodingMode1(node[nodeIdx]);
else
for(int nodeIdx=0;nodeIdx< N;++nodeIdx)
  DecodingMode2(node[nodeIdx]);
```

Further, in the embodiments of the present disclosure, in response to the decoding mode indicated by the mode flag information being the first context decoding, geometry information for each node in the current node group is decoded using first context. In response to the decoding mode indicated by the mode flag information being the second context decoding, geometry information for each node in the current node group is decoded using second context.

In addition, in the embodiments of the present disclosure, the bitstream may be decoded to determine length information corresponding to the current node group among the at least one node group; and the number of nodes in the current node group is determined according to the length information.

In addition, in the embodiments of the present disclosure, a first cost value of encoding geometry information for nodes in the current node group using octree coding and a second cost value of encoding geometry information for nodes in the current node group using planar coding may further be determined using a rate distortion optimization algorithm. In response to the first cost value being less than or equal to the second cost value, it is determined that a coding mode corresponding to the current node group is octree coding; or in response to the first cost value being greater than the second cost value, it is determined that a coding mode corresponding to the current node group is planar coding.

For example, in the embodiments of the present disclosure, in the octree coding process, the nodes in the level to be coded are partitioned into different Groups. Assuming that the number of nodes in each Group is N (N=1024), at the encoding side, the rate distortion optimization algorithm is adopted to adaptively select the planar coding or octree coding for each group. Assuming that the coding mode of the current Group is codeMode, the specific algorithm procedure is as follows:

```
Uint octreeCost=0;
for(int nodeIdx=0;nodeIdx< N;++nodeIdx)
  octreeCost+=estimateOcctreeCodingBits(node[nodeIdx]);
Uint planarCost=0;
for(int nodeIdx=0;nodeIdx< N;++nodeIdx)
  planarCost+=estimatePlanarCodingBits(node[nodeIdx]);
if(octreeCost<planarCost)
codeMode=0;
else
codeMode=1;
codeCodeMode(codeMode);
if(codeMode)
for(int nodeIdx=0;nodeIdx< N;++nodeIdx)
  PlanarCoding(node[nodeIdx]);
else
for(int nodeIdx=0;nodeIdx< N;++nodeIdx)
  octreeCoding(node[nodeIdx]);
```

Further, in the embodiments of the present disclosure, the nodes to be encoded in the current level are partitioned into different Groups; then at the encoding side, an optimal coding mode (codeMode) is selected using the rate distortion optimization criterion; and finally, a coding mode of the current Group is encoded for each Group. When a cost of the octree coding (the first cost value) is less than a cost of the planar coding (the second cost value), the current Group selects to adopt the octree coding for encoding, otherwise, the planar coding is selected.

Further, in the embodiments of the present disclosure, a third cost value of encoding geometry information for nodes in the current node group using first context and a fourth cost value of encoding geometry information for the nodes in the current node group using second context may further be determined using a rate distortion optimization algorithm. In response to the third cost value being less than or equal to the fourth cost value, it is determined that a coding mode corresponding to the current node group is first context encoding; or in response to the third cost value being greater than the fourth cost value, it is determined that a coding mode corresponding to the current node group is second context encoding.

For example, in the embodiments of the present disclosure, in the octree coding process, the nodes in the level to be encoded are partitioned into different Groups. Assuming that the number of nodes in each Group is N (N=1024), at the encoding side, the rate distortion optimization algorithm is adopted to adaptively select the context coding model 1 or context coding model 2 for each group. Assuming that the coding mode of the current group is codeMode, the specific algorithm procedure is as follows:

```
  Uint codeMode1Cost=0;
  for(int nodeIdx=0;nodeIdx< N;++nodeIdx)
      codeMode1Cost +=estimateCodeMode1Bits(node[nodeIdx]);
  Uint codeMode2Cost =0;
  for(int nodeIdx=0;nodeIdx< N;++nodeIdx)
      codeMode2Cost += estimateCodeMode2Bits (node[nodeIdx]);
  if(codeMode1Cost < codeMode2Cost)
    codeMode=0;
  else
    codeMode=1;
codeCodeMode(codeMode);
  if(codeMode)
    for(int nodeIdx=0;nodeIdx< N;++nodeIdx)
      CodingMode1(node[nodeIdx]);
  else
    for(int nodeIdx=0;nodeIdx< N;++nodeIdx)
      CodingMode2(node[nodeIdx]);
```

It is to be understood that the nodes to be encoded in the current level are partitioned into different Groups; then at the encoding side, an optimal coding mode (codeMode) is selected using the rate distortion optimization criterion; and finally, a coding mode of the current Group is encoded for each Group. When a cost of the context coding model 1 (third cost value) is less than a cost of context coding model 2 (fourth cost value), the current Group selects to adopt the context coding model 1, otherwise, the context coding model 2 is selected.

Step 103: a prediction value of a node in the current node group is determined according to a decoding mode indicated by the mode flag information.

In the embodiments of the present disclosure, after decoding the bitstream to determine the mode flag information corresponding to the current node group among the at least one node group, the prediction value of the node in the current node group may be determined according to the decoding mode indicated by the mode flag information.

It is to be understood that in the embodiments of the present disclosure, for the G-PCC encoding and decoding framework, in response to the decoding mode indicated by the mode flag information being the octree decoding, the geometry information for each node in the current node group is decoded using the octree decoding to obtain the prediction value; or in response to the decoding mode indicated by the mode flag information being the planar decoding, the geometry information for each node in the current node group is decoded using the planar decoding to obtain the prediction value.

Further, in the embodiments of the present disclosure, after the prediction value of the node in the current node group is determined according to the decoding mode indicated by the mode flag information, each node in the node group corresponds to a respective prediction value.

For example, in the embodiments of the present disclosure, for the G-PCC encoding and decoding framework, since the decoding mode indicated by the mode flag information is the octree decoding, and the current node group includes eight nodes, after the prediction value of each node in the current node group is determined using the octree decoding, eight prediction values may be obtained, which correspond to the eight nodes, respectively.

That is, in the embodiments of the present disclosure, for the G-PCC encoding and decoding framework, at the decoding side, the nodes in the level to be decoded are partitioned first to obtain different Groups. Before decoding the geometry information of each Group, the decoding mode of the current Group is decoded firstly, and then, it is determined whether the current group adopts the octree decoding or planar decoding according to the decoding mode of the current Group, so that the geometry coding efficiency of the point cloud may be improved.

It is to be understood that in the embodiments of the present disclosure, for the AVS-PCC encoding and decoding framework, in response to the decoding mode indicated by the mode flag information being the first context decoding, the geometry information for each node in the current node group is decoded using the first context decoding to obtain the prediction value; or in response to the decoding mode indicated by the mode flag information being the second context decoding, the geometry information for each node in the current node group is decoded using the second context decoding to obtain the prediction value.

That is, in the embodiments of the present disclosure, at the decoding side, for the AVS-PCC encoding and decoding framework, the nodes in the level to be decoded are partitioned first to obtain different Groups. Before decoding the geometry information of each Group, the decoding mode of the current Group is decoded firstly, and then, it is determined whether the current group adopts the context coding model 1 or context coding model 2 according to the decoding mode of the current Group, so that the geometry coding efficiency of the point cloud may be improved.

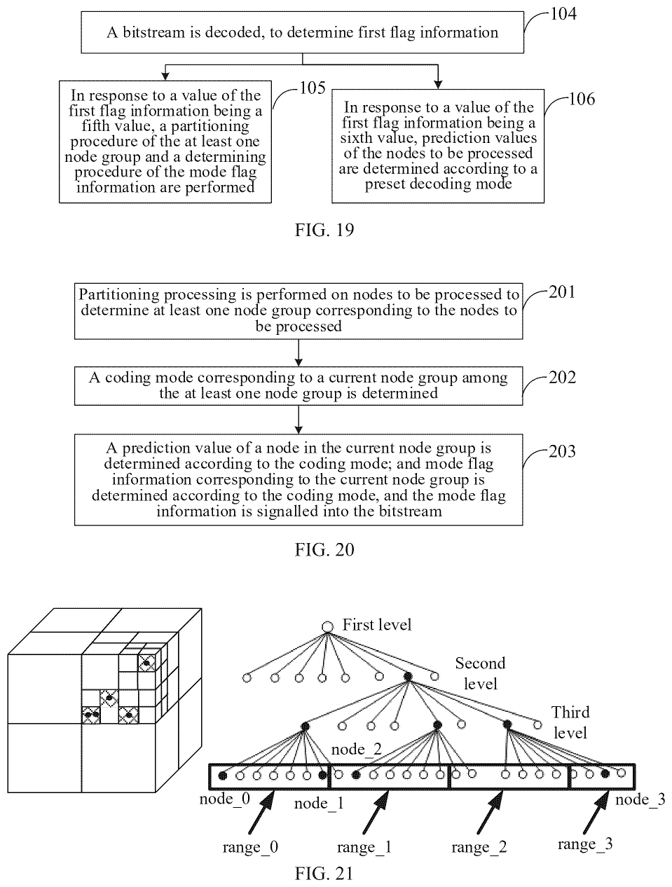

In addition, in the embodiments of the present disclosure, referring to FIG. 19, a flowchart of a decoding method provided in the embodiments of the present disclosure is illustrated. As illustrated in FIG. 19, the decoder may further decode the bitstream to determine first flag information (Step 104). In response to a value of the first flag information being a fifth value, a partitioning procedure of the at least one node group and a determining procedure of the mode flag information are performed (Step 105) to improve the geometry coding efficiency of the point cloud. In response to a value of the first flag information being a sixth value, prediction values of the nodes to be processed are determined according to a preset decoding mode (Step 106).

That is, in the embodiments of the present disclosure, the first flag information is used to determine whether to adopt the decoding methods proposed in the embodiments of the present disclosure, such as, the decoding methods illustrated in the above steps 101 to 103.

It is to be noted that, in the embodiments of the present disclosure, the specific numerical values of the fifth and sixth values are not limited by the present disclosure. For example, the fifth value may be 1, and the sixth value may be 0.

It is to be understood that in the embodiments of the present disclosure, the preset decoding mode may be a decoding mode other than the partitioning procedure based on the node group and the determining procedure of the mode flag information in the present disclosure, which is not limited in the present disclosure.

It is to be noted that, in the embodiments of the present disclosure, the first flag information may be information at any layer level. For example, the first flag information may be at a frame layer level, a group layer level, a slice layer level, or the like.

It is to be noted that, in the embodiments of the present disclosure, the layer level of the first flag information depends on a scale of the point cloud data being processed. For example, when decoding one point cloud picture, the first flag information may be at the frame layer level; when partitioning the node groups using the node group partitioning process proposed in the embodiments of the present disclosure, the first flag information may be at the group layer level.

Further, in some embodiments of the present disclosure, for the G-PCC encoding and decoding framework, an initial length parameter may further be determined. Based on the initial length parameter, an optimal partitioning mode and at least one node group corresponding to the optimal partitioning mode are determined using a recursive algorithm. For a current node group among the at least one node group corresponding to the optimal partitioning mode, a fifth cost value of encoding geometry information for nodes in the current node group using octree coding and a sixth cost value of encoding geometry information for the nodes in the current node group using planar coding are determined using a rate distortion optimization algorithm. In response to the fifth cost value being less than or equal to the sixth cost value, it is determined that a coding mode corresponding to the current node group is the octree coding; or in response to the fifth cost value being greater than the sixth cost value, it is determined that a coding mode corresponding to the current node group is the planar coding.

It is to be noted that, in the embodiments of the present disclosure, the initial length parameter may be determined according to the number of the nodes to be processed.

For example, in the embodiments of the present disclosure, at the encoding side, adaptive partitioning may be performed on the nodes in the coding level to be encoded using the rate distortion optimization selection algorithm, and then the rate distortion optimization is performed to select the optimal coding mode in each Group. Specifically, assuming that the number of the nodes in the current coding level is nodeCount, the maximum Length of the initialized Group is nodeCount, and then the optimal Group partitioning mode and the optimal coding mode of each Group are adaptively selected based on the recursive algorithm:

```
  Const uint minLength=M; (M=16)
  Uint curBestCost=0;
  Bool curCodeMode=0;
  Vector<pair<int,bool>>divideLength;
  Uint RDOSelector(Uint startIdx, Uint endIdx, Uint &curBestCost,
  Bool& curCodeMode){
    Uint curOctreeCost=0;
    For(int nodeIdx=0;nodeIdx<nodeCount;++nodeIdx)
        curOctreeCost+= estimateOcctreeCodingBits (node[nodeIdx]);
      Uint curPlanarCost=0;
    For(int nodeIdx=0;nodeIdx<nodeCount;++nodeIdx)
        curPlanarCost += estimatePlanarCodingBits (node[nodeIdx]);
    if(curPlanarCost< curOctreeCost){
      curCodeMode=1; curBestCost= curPlanarCost;}
    else{
      curCodeMode=1; curBestCost= curPlanarCost;}
    if(endIdx − startIdx<= minLength)
      return { curBestCost , curCodeMode};
    ///< divide current Group
    Uint curLeftChildBestCost=0;
    Bool curLeftChildCodeMode=0;
    RDOSelector(startIdx, startIdx+(endIdx−startIdx)/2,
    curLeftChildBestCost,
curLeftChildCodeMode);
      Uint curRightChildBestCost=0;
    Bool curRightChildCodeMode=0;
    RDOSelector( startIdx+(endIdx−startIdx)/2,endIdx,
    curRightChildBestCost,
curRightChildCodeMode);
    If(curLeftChildBestCost+ curRightChildBestCost< curBestCost){
    divideLength.push_back({curLeftChildBestCost ,
    curLeftChildCodeMode });
      divideLength.push_back({curRightChildBestCost ,
      curRightChildCodeMode });}
  else
    divideLength.push_back({curBestCost , curCodeMode });
  }
```

Further, in the embodiments of the present disclosure, for the AVS-PCC encoding and decoding framework, an initial length parameter may further be determined. Based on the initial length parameter, an optimal partitioning mode and at least one node group corresponding to the optimal partitioning mode are determined using a recursive algorithm. For a current node group among the at least one node group corresponding to the optimal partitioning mode, a seventh cost value of encoding geometry information for nodes in the current node group using first context and an eighth cost value of encoding geometry information for the nodes in the current node group using second context are determined using a rate distortion optimization algorithm. In response to the seventh cost value being less than or equal to the eighth cost value, it is determined that a coding mode corresponding to the current node group is the first context encoding; or in response to the seventh cost value being greater than the eighth cost value, it is determined that a coding mode corresponding to the current node group is the second context encoding.

For example, in some embodiments of the present disclosure, at the encoding side, adaptive partitioning may be performed on the nodes in the coding level to be encoded using the rate distortion optimization selection algorithm, and then the rate distortion optimization is performed in each Group, to select the optimal coding mode. Specifically, assuming that the number of nodes in the current coding level is nodeCount, the maximum Length of the initialized Group is nodeCount, and then the optimal Group partitioning mode and the optimal coding mode of each Group are adaptively selected based on the recursive algorithm:

```
  Const uint minLength=M; (M=16)
  Uint curBestCost=0;
  Bool curCodeMode=0;
  Vector<pair<int,bool>>divideLength;
  Uint RDOSelector(Uint startIdx, Uint endIdx, Uint &curBestCost,
  Bool& curCodeMode){
    Uint curOctreeCost=0;
    For(int nodeIdx=0;nodeIdx<nodeCount;++nodeIdx)
          curOctreeCost+= estimateOcctreeCodingBits (node[nodeIdx]);
        Uint curPlanarCost=0;
    For(int nodeIdx=0;nodeIdx<nodeCount;++nodeIdx)
          curPlanarCost += estimatePlanarCodingBits (node[nodeIdx]);
    if(curPlanarCost< curOctreeCost){
      curCodeMode=1; curBestCost= curPlanarCost;}
      else{
        curCodeMode=1; curBestCost= curPlanarCost;}
    if(endIdx − startIdx<= minLength)
        return { curBestCost , curCodeMode};
    ///< divide current Group
      Uint curLeftChildBestCost=0;
    Bool curLeftChildCodeMode=0;
    RDOSelector(startIdx, startIdx+(endIdx−startIdx)/2,
    curLeftChildBestCost,
curLeftChildCodeMode);
        Uint curRightChildBestCost=0;
    Bool curRightChildCodeMode=0;
    RDOSelector( startIdx+(endIdx−startIdx)/2,endIdx,
    curRightChildBestCost,
curRightChildCodeMode);
    If(curLeftChildBestCost+ curRightChildBestCost< curBestCost){
    divideLength.push_back({curLeftChildBestCost ,
    curLeftChildCodeMode });
        divideLength.push_back({curRightChildBestCost ,
        curRightChildCodeMode });}
        else
        divideLength.push_back({curBestCost , curCodeMode });
    }
```

Further, in the embodiments of the present disclosure, in the AVS-PCC encoder, different LCU coding units may be obtained first by using octree partitioning, and then, at the encoding side, predictive tree coding or multiway-tree coding is adaptively selected for each LCU coding unit by using simple point cloud density. Similarly, the optimal coding mode may be selected adaptively using the rate distortion optimization algorithm, and predictive tree mode, multiway-tree coding model 1 or multiway-tree coding model 2 may be selected for encoding by using the rate distortion optimization selection algorithm, so that the geometry information coding efficiency of the point cloud is improved.

It is to be seen that in the embodiments of the present disclosure, the current level to be encoded are partitioned at the encoding side, to obtain different Groups; next, the optimal coding mode of each Group is selected for each Group at the encoding side using the rate distortion optimization criterion, and then the optimal coding mode is used to adaptively encode the nodes of the current Group, so that the geometry coding efficiency of point clouds is improved.

In the following, geometry coding lossless and attribute information coding lossless are used as the test conditions. Bits Per Point (Bpp) is the performance measurement indicator of geometry lossless coding, and 100% is the coding efficiency. The Table 1 below shows the compression performance of a single sequence, and Table 2 shows the performance results under lossless geometry and lossless attributes. It can be seen that in the case of geometry lossless coding, the compression efficiency may be reached nearly 20% on some sequences in the embodiments of the present disclosure.

TABLE 1

| Test Sequences | Test results (Geometry_bpp) |
|---|---|
| boxer_viewdep_vox12 | 89.302% |
| egyptian_mask_vox12 | 99.293% |
| facade_00009_vox12 | 99.222% |
| facade_00015_vox14 | 99.555% |
| frog_00067_vox12 | 96.845% |
| house_without_roof_00057_vox12 | 99.672% |
| longdress_viewdep_vox12 | 91.336% |
| loot_viewdep_vox12 | 89.036% |
| redandblack_viewdep_vox12 | 91.731% |
| shiva_00035_vox12 | 99.062% |
| soldier_viewdep_vox12 | 89.252% |
| arco_valentino_dense_vox12 | 99.866% |
| arco_valentino_dense_vox20 | 99.941% |
| egyptian_mask_vox20 | 99.071% |
| facade_00009_vox20 | 99.154% |
| facade_00015_vox20 | 98.989% |
| facade_00064_vox14 | 96.055% |
| facade_00064_vox20 | 99.070% |
| frog_00067_vox20 | 98.862% |
| head_00039_vox20 | 99.230% |
| house_without_roof_00057_vox20 | 98.800% |
| landscape_00014_vox14 | 99.994% |
| landscape_00014_vox20 | 98.710% |
| palazzo_carignano_dense_vox14 | 99.879% |
| palazzo_carignano_dense_vox20 | 99.947% |
| shiva_00035_vox20 | 99.345% |
| stanford_area_2_vox16 | 99.590% |
| stanford_area_2_vox20 | 99.610% |
| staue_klimt_vox12 | 95.984% |
| staue_klimt_vox20 | 98.876% |
| ulb_unicorn_hires_vox15 | 98.008% |
| ulb_unicorn_hires_vox20 | 99.327% |
| ulb_unicorn_vox20 | 99.907% |

TABLE 2

| | Geometry Lossless, Attribute Lossless [all intra] | | | |
|---|---|---|---|---|
| | bpip ratio[%] | | | |
| CW ai | Geometry | Colour | Reflectance | Total |
| Cat1-A average | 97.8% | 100.0% | | 99.3% |
| Cat1-B average | 99.2% | 100.0% | | 99.5% |
| Cat3-fused average | 98.9% | 100.0% | 100.0% | 99.4% |
| Cat3-frame average | 100.0% | | 100.0% | 100.0% |
| Overall average | 99.1% | 100.0% | 100.0% | 99.5% |

| | |
|---|---|
| Avg.Enc. Time[%] | #NUM! |
| Avg. Dec. Time[%] | #NUM! |

To sum up, in the embodiments of the present disclosure, partitioning processing is performed on the nodes to be processed obtained after octree partitioning, to obtain the at least one node group, where the manners for partitioning the node groups are not specifically limited by the present disclosure, so as to adaptively select the decoding mode suitable for each node group, including octree decoding, planar decoding, first context decoding, and second context decoding, or the like. In this way, the different node groups are decoded according to the different decoding modes, so that the geometry information coding efficiency in each node group may be ensured to achieve local optimum, the geometry coding efficiency of the point cloud is greatly improved, thereby improving the encoding and decoding performance of the point cloud.

The embodiments of the present disclosure provide a decoding method. The decoder performs partitioning processing on the nodes to be processed to determine the at least one node group corresponding to the nodes to be processed; decodes the bitstream to determine the mode flag information corresponding to the current node group among the at least one node group; and determines the prediction value of the node in the current node group according to the decoding mode indicated by the mode flag information. In this way, by partitioning the nodes to be processed into different node groups, and then for each different node group, the coding mode suitable for the node group is selected, so that encoding is performed based on the coding mode suitable for the node group, thereby effectively improving the geometry coding efficiency of the point cloud, and then improving the encoding and decoding performance of the point cloud.

An embodiment of the present disclosure provides an encoding method. FIG. 20 illustrates a flowchart of an encoding method provided in the embodiments of the present disclosure. As illustrated in FIG. 20, when encoding processing is performed on the point cloud, following steps may be included.

Step 201: partitioning processing is performed on nodes to be processed to determine at least one node group corresponding to the nodes to be processed.

In the embodiments of the present disclosure, partitioning processing may be performed on the nodes to be processed first, to determine the at least one node group corresponding to the nodes to be processed.

It is to be noted that the encoding method in the embodiments of the present disclosure specifically refers to a point cloud encoding method, which may be applied to a point cloud encoder (also referred to as an “encoder” for short).

It is to be noted that, in the embodiments of the present disclosure, a point cloud to be processed includes multiple nodes to be processed. The nodes to be processed in the point cloud to be processed may be taken as the nodes to be encoded in the point cloud to be processed when encoding is performed on the nodes to be processed.

Further, in the embodiments of the present disclosure, each node to be processed in the point cloud to be processed corresponds to one piece of geometry information and one piece of attribute information; where the geometry information represents a spatial relationship of the point, and the attribute information represents relevant information of the attribute of the point.

Here, the attribute information may be color information, or may be reflectance or other attributes, which is not specifically limited in the embodiments of the present disclosure. When the attribute information is color information, which may specifically be color information in any color space. For example, the attribute information may be color information in the RGB space, color information in the YUV space, color information in the YCbCr space, or the like, which is not limited in the embodiments of the present disclosure.

It should be noted that in the embodiments of the present disclosure, in the octree encoding process, the nodes to be processed may be part or all of nodes in one of levels to be encoded, or part or all of nodes in part of the levels to be encoded, or part or all of nodes in all levels to be encoded.

For example, in the embodiments of the present disclosure, in the octree encoding process, all nodes in the second coding level of the octree may be taken as the nodes to be processed; or part of nodes in the second coding level of the octree (for example, four nodes thereof) may be taken as the nodes to be processed.

For example, in the embodiments of the present disclosure, in the octree encoding process, the octree has a total of ten coding levels, and all nodes in the second, third and fourth levels may be taken as the nodes to be processed; or part of nodes in the second, third and fourth levels may be taken as the nodes to be processed. For example, the nodes to be processed may include all nodes in the second level, part of nodes in the third level, and part of nodes in the fourth level.

For example, in the embodiments of the present disclosure, in the octree encoding process, there are eight nodes in the i-th level, and there are sixty-four nodes in the (i+1)-th level; where i is an integer greater than 0. The nodes to be processed may include four nodes in the i-th level and thirty-two nodes in the (i+1)-th level.

For example, in the embodiments of the present disclosure, in the octree encoding process, the octree has a total of ten coding levels, and all nodes in the ten coding levels may be taken as the nodes to be processed; or part of the nodes in the ten coding levels may be taken as the nodes to be processed. For example, the nodes to be processed may include half of the nodes in each level of the ten coding levels.

Further, in the embodiments of the present disclosure, the nodes to be processed may be partitioned to obtain the at least one node group.

For example, in the embodiments of the present disclosure, in the octree encoding process, the nodes to be processed are all nodes in the i-th and (i+1)-th levels, and partitioning processing may be performed on all the nodes in the i-th and (i+1)-th levels, to obtain the at least one node group.

For example, in the embodiments of the present disclosure, in the octree encoding process, there are eight nodes in the i-th level, there are sixty-four nodes in the (i+1)-th level, the nodes to be processed include four nodes in the i-th level and thirty-two nodes in the (i+1)-th level, and partitioning processing may be performed on the four nodes in the i-th level and thirty-two nodes in the (i+1)-th level, to obtain the at least one node group.

For example, in the embodiments of the present disclosure, in the octree encoding process, the nodes to be processed are part of nodes in the i-th level, and partitioning processing is performed on the part of nodes in the i-th level nodes, to obtain the at least one node group.

For example, in the embodiments of the present disclosure, in the octree encoding process, the octree has a total of ten coding level, and the nodes to be processed are all nodes in these ten coding levels, and partitioning processing may be performed on all the nodes in these ten coding levels, to obtain the at least one node group.

In some embodiments of the present disclosure, nodes in one level obtained after octree partitioning may be determined as one node group.

For example, in the embodiments of the present disclosure, in the octree encoding process, nodes in the i-th level may be partitioned into one node group.

For example, in the embodiments of the present disclosure, in the octree encoding process, nodes in the i-th level may be partitioned into one node group, and nodes in the (i+1)-th level may be partitioned into one node group.

In some embodiments, nodes in multiple levels obtained after octree partitioning may also be determined as one node group.

For example, in the embodiments of the present disclosure, in the octree encoding process, all nodes in the i-th and (i+1)-th levels are partitioned into one node group.

For example, in the embodiments of the present disclosure, in the octree encoding process, part of nodes in the i-th level and part of nodes in the (i+1)-th level may be partitioned into one node group.

In some embodiments of the present disclosure, nodes in one level obtained after octree partitioning may be determined as multiple node groups.

For example, in the embodiments of the present disclosure, in the octree encoding process, the nodes in the i-th level may be partitioned into four node groups, and each node group includes four nodes.

For example, in the embodiments of the present disclosure, in the octree encoding process, nodes in the (i+2)-th level may be partitioned into three node groups, where both node groups 1 and 2 include eight nodes, and node group 3 includes four nodes.

For example, in the embodiments of the present disclosure, in the octree encoding process, the nodes in the i-th level may be partitioned into four node groups, and each node group includes four nodes. Accordingly, the nodes in the (i+1)-th level may be partitioned into four node groups, and each node group includes eight nodes.

For example, in the embodiments of the present disclosure, in the octree encoding process, the nodes in the i-th level may be partitioned into four node groups, where three node groups include eight nodes and one node group includes four nodes. Accordingly, the nodes in the (i+1)-th level may be partitioned into four node groups, and each node group includes eight nodes.

It should be noted that in the embodiments of the present disclosure, when partitioning processing is performed on the nodes to be processed, the number of nodes in the node group may be limited by a preset threshold; that is, the number of nodes in each different node group among the at least one node group is less than or equal to the preset threshold.

For example, in the embodiments of the present disclosure, the nodes to be encoded (the nodes to be processed) in the current level are partitioned to obtain different Groups (node groups), where the number of nodes in each Group is N (N=1024), and the preset threshold is 1024, that is, among these Groups, the number of nodes in each Group is equal to the preset threshold.

For example, in the embodiments of the present disclosure, the preset threshold is 10, and point partitioning processing is performed on the nodes in the i-th level according to the preset threshold to obtain four node groups, where node group 1 includes eight nodes, node group 2 includes eight nodes, node group 3 includes four nodes, and node group 4 includes four nodes, that is, the number of nodes in each node group is less than the preset threshold.

For example, in the embodiments of the present disclosure, the preset threshold is 10, and partitioning processing is performed on the nodes in the third level of the octree according to the preset threshold to obtain three node groups, where node group 1 includes ten nodes, node group 2 includes eight nodes, and node group 3 includes four nodes, that is, the number of nodes in node group 1 is equal to the preset threshold, and the number of nodes in node group 2 and the number of node in node group 3 are less than the preset threshold.

For example, in the embodiments of the present disclosure, assuming that the number of nodes in the current level to be encoded is nodeCount, the maximum length (preset threshold) of the initialized Group is nodeCount.

Further, in the embodiments of the present disclosure, among the at least one node group obtained after partitioning processing is performed on the nodes to be processed, the numbers of nodes in different node groups are not all identical.

For example, in the embodiments of the present disclosure, point partitioning processing is performed on the nodes in the i-th level, to obtain three node groups, where node group 1 includes eight nodes, node group 2 includes eight nodes, and node group 3 includes four nodes. That is, the number of nodes in node group 1 is the same as that in node group 2, and the number of nodes in node group 3 is different from that in node group 1 and different from that in node group 2.

In some embodiments of the present disclosure, adaptive partitioning processing may further be performed on the nodes to be processed according to a rate distortion optimization algorithm, to determine the at least one node group.

For example, in the embodiments of the present disclosure, the nodes to be processed are nodes in all coding levels of octree, including nodes in twenty coding levels. Adaptive partitioning processing is performed on all the nodes in these twenty coding levels according to the rate distortion optimization algorithm, to obtain thirty-two node groups.

For example, in the embodiments of the present disclosure, the nodes to be processed are nodes in three coding levels of octree, and adaptive partitioning processing is performed on the nodes in the three coding levels according to the rate distortion optimization algorithm, to obtain three node groups.

For example, in the embodiments of the present disclosure, the nodes to be processed are all nodes in the first level, part of nodes in the second level and part of nodes in the third level of octree. Adaptive partitioning processing is performed on all the nodes in the first level, part of nodes in the second level and part of nodes in the third level according to the rate distortion optimization algorithm, to obtain ten node groups.

Furthermore, in the embodiments of the present disclosure, length information corresponding to the current node group may be determined according to the number of nodes in the current node group among the at least one node group; and the length information is signalled (or written) into the bitstream.

For example, in the embodiments of the present disclosure, the current node group includes eight nodes, then the length information is eight nodes, and the length information is signalled into the bitstream.

Step 202: a coding mode corresponding to a current node group among the at least one node group is determined.

In the embodiments of the present disclosure, after performing partitioning processing on the nodes to be processed to determine the at least one node group corresponding to the nodes to be processed, the coding mode corresponding to the current node group among the at least one node group may be determined.

It is to be noted that in the embodiments of the present disclosure, in response to determining that the coding mode indicated by the mode flag information is octree coding, a value of the mode flag information is set to a first value. In response to determining that the coding mode indicated by the mode flag information is planar coding, a value of the mode flag information is set to a second value.

It is to be noted that, in the embodiments of the present disclosure, the first and second values are used to indicate specific encoding and decoding modes in the G-PCC encoding and decoding framework, respectively.

Further, in the embodiments of the present disclosure, the specific numerical values of the first and second values are not limited by the present disclosure. For example, the first value may be 0, and the second value may be 1.

In some embodiments, the nodes to be decoded in the current level are partitioned, to obtain different Groups, where the number of nodes in each Group is N (N=1024), which is consistent with the encoding side. Then, before decoding the geometry information of each Group, the decoding mode codeMode of the current Group is decoded first. If the codeMode of the current Group is 0, octree decoding is adopted; otherwise, planar decoding is adopted. The details are as follows:

```
codeMode=decodeCodeMode( );
if(codeMode)
for(int nodeIdx=0;nodeIdx< N;++nodeIdx)
  PlanarDecoding(node[nodeIdx]);
else
for(int nodeIdx=0;nodeIdx< N;++nodeIdx)
  octreeDecoding(node[nodeIdx]);
```

It should be noted that in the embodiments of the present disclosure, in response to determining that the coding mode indicated by the mode flag information is first context encoding, a value of the mode flag information is set to a third value. In response to determining that the coding mode indicated by the mode flag information is second context encoding, a value of the mode flag information is set to a fourth value.

It should be noted that, in the embodiments of the present disclosure, the third and fourth values are used to indicate specific encoding and decoding modes in the AVS-PCC encoding and decoding framework, respectively.

In some embodiments, for the AVS-PCC encoding and decoding framework, when the value of the mode flag information is the third value, it indicates that the coding mode is the first context coding; or when the value of the mode flag information is the fourth value, it indicates that the coding mode is the second context coding.

Further, in the embodiments of the present disclosure, the specific numerical values of the third and fourth values are not limited by the present disclosure. For example, the third value may be 0, and the fourth value may be 1.

In some embodiments, the nodes to be decoded in the current level are partitioned, to obtain different Groups (node groups), where the number of nodes in each Group is N (N=1024). Then, before decoding the geometry information of each Group, the decoding mode codeMode (mode flag information) of the current Group is decoded first. If the codeMode of the current Group is 0, the context coding model 1 is adopted for decoding; otherwise, the context coding model 2 is used for decoding. The details are as follows:

```
codeMode=decodeCodeMode( );
if(codeMode)
for(int nodeIdx=0;nodeIdx< N;++nodeIdx)
  DecodingMode1(node[nodeIdx]);
else
for(int nodeIdx=0;nodeIdx< N;++nodeIdx)
  DecodingMode2(node[nodeIdx]);
```

In addition, in the embodiments of the present disclosure, a first cost value of encoding geometry information for nodes in the current node group using octree coding and a second cost value of encoding geometry information for nodes in the current node group using planar coding may further be determined using a rate distortion optimization algorithm. In response to the first cost value being less than or equal to the second cost value, it is determined that a coding mode corresponding to the current node group is octree coding; or in response to the first cost value being greater than the second cost value, it is determined that a coding mode corresponding to the current node group is planar coding.

For example, in the embodiments of the present disclosure, FIG. 21 is a schematic diagram of planar coding provided in the embodiments of the present disclosure. As illustrated in FIG. 21, in the octree coding process, the nodes in the level to be coded are partitioned into different Groups. Assuming that the number of nodes in each Group is N (N=1024), at the encoding side, the rate distortion optimization algorithm is adopted to adaptively select the planar coding or octree coding for each group. Assuming that the coding mode of the current Group is codeMode, the specific algorithm procedure is as follows:

```
Uint octreeCost = 0;
for(int nodeIdx=0;nodeIdx< N;++nodeIdx)
  octreeCost+=estimateOcctreeCodingBits(node[nodeIdx]);
Uint planarCost=0;
for(int nodeIdx=0;nodeIdx< N;++nodeIdx)
  planarCost+=estimatePlanarCodingBits(node[nodeIdx]);
if(octreeCost<planarCost)
codeMode=0;
else
codeMode=1;
codeCodeMode(codeMode);
if(codeMode)
for(int nodeIdx=0;nodeIdx< N;++nodeIdx)
  PlanarCoding(node[nodeIdx]);
else
for(int nodeIdx=0;nodeIdx< N;++nodeIdx)
  octreeCoding(node[nodeIdx]);
```

Further, as illustrated in FIG. 21, the nodes to be encoded in the current level are partitioned into different Groups; then at the encoding side, an optimal coding mode (codeMode) is selected using the rate distortion optimization criterion; and finally, a coding mode of the current Group is encoded for each Group. When a cost of the octree coding (the first cost value) is less than a cost of the planar coding (the second cost value), the current Group selects to adopt the octree coding for encoding, otherwise, the planar coding is selected.

Further, in the embodiments of the present disclosure, a third cost value of encoding geometry information for nodes in the current node group using first context and a fourth cost value of encoding geometry information for the nodes in the current node group using second context may further be determined using a rate distortion optimization algorithm. In response to the third cost value being less than or equal to the fourth cost value, it is determined that a coding mode corresponding to the current node group is first context encoding; or in response to the third cost value being greater than the fourth cost value, it is determined that a coding mode corresponding to the current node group is second context encoding.

For example, in the embodiments of the present disclosure, in the octree coding process, the nodes in the level to be encoded are partitioned into different Groups. Assuming that the number of nodes in each Group is N (N=1024), at the encoding side, the rate distortion optimization algorithm is adopted to adaptively select the context coding model 1 or context coding model 2 for each group. Assuming that the coding mode of the current group is codeMode, the specific algorithm procedure is as follows:

```
    Uint codeMode1Cost=0;
    for(int nodeIdx=0;nodeIdx< N;++nodeIdx)
      codeMode1Cost +=estimateCodeMode1Bits(node[nodeIdx]);
    Uint codeMode2Cost =0;
    for(int nodeIdx=0;nodeIdx< N;++nodeIdx)
      codeMode2Cost += estimateCodeMode2Bits (node[nodeIdx]);
    if(codeMode1Cost < codeMode2Cost)
      codeMode=0;
    else
      codeMode=1;
codeCodeMode(codeMode);
  if(codeMode)
    for(int nodeIdx=0;nodeIdx< N;++nodeIdx)
      CodingMode1(node[nodeIdx]);
  else
    for(int nodeIdx=0;nodeIdx< N;++nodeIdx)
      CodingMode2(node[nodeIdx]);
```

It is to be understood that the nodes to be encoded in the current level are partitioned into different Groups; then at the encoding side, an optimal coding mode (codeMode) is selected using the rate distortion optimization criterion; and finally, a coding mode of the current Group is encoded for each Group. When a cost of the context coding model 1 (third cost value) is less than a cost of context coding model 2 (fourth cost value), the current Group selects to adopt the context coding model 1, otherwise, the context coding model 2 is selected.

In the embodiments of the present disclosure, for the context model 1, in the AVS-PCC encoder, the model includes sub-level neighbor prediction for a current point and neighbor prediction for a current point level. The details are as follows.

### (1) Sub-Level Neighbor Prediction for a Current Point

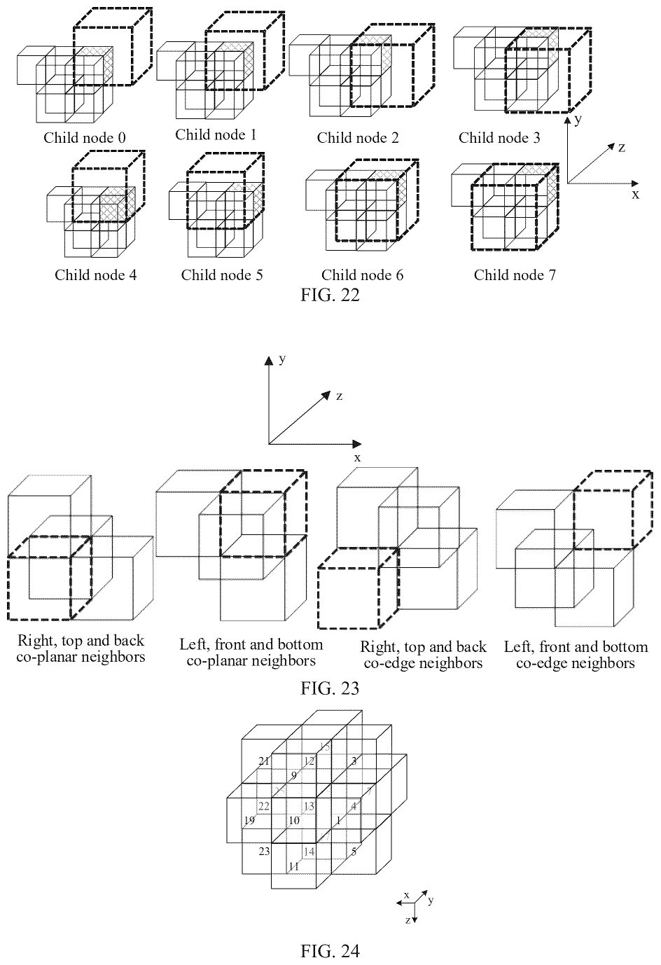

Under the octree breadth-first traversal partitioning scheme, neighbor information that could be obtained when encoding child nodes of the current point includes neighbor child nodes in the left, front and bottom directions. The context model of the child node level is designed as follows. For a child node level to be encoded, occupancy status of three co-planar nodes, three co-edge nodes and one co-vertex node in the left, front and bottom directions at the same level as the child node to be encoded as well as that of the node located two node edge lengths away in the negative direction along the dimension with the shortest node edge length from the current child node to be encoded are found. Taking the node with the shortest edge length in the X dimension as an example, FIG. 22 is a schematic diagram of reference nodes of a child node, and the reference nodes selected for each child node is illustrated in FIG. 22, where the dashed box node is the current node, the node filled with grids is the current child node to be encoded, and the solid box node is the reference node selected for each child node. Considering the occupancy status of three co-planar nodes, three co-edge nodes and the node located two node edge lengths away in the negative direction along the dimension with the shortest node edge length from the current child node to be encoded, these 7 nodes have a total of 2⁷=128 occupancy statuses. If not all of them are unoccupied, there are a total of 2⁷−1=127 statuses, and one context is assigned for each status. If all of these 7 nodes are unoccupied, the occupancy status of the co-vertex neighboring node is considered. There are two possibilities for the co-vertex neighbor: occupied or unoccupied. One separate context is assigned for the case where the co-vertex neighboring node is occupied. If the co-vertex neighbor is also unoccupied, the occupancy statuses of neighbors at the current node layer to be described below are considered. That is, the neighbors of the child node level to be encoded correspond to a total of 127+2−1=128 contexts.

### (2) Neighbor Prediction for a Current Point Level

For example, FIG. 23 is a schematic diagram of reference neighboring nodes of a current point. If eight reference nodes in the same level of the child node to be encoded are not occupied, the occupancy status of four groups of neighbors of the current node level as illustrated in FIG. 23 is considered. The dashed box node is the current node, and the solid box nodes are the neighboring nodes.

For the current node level, the context is determined as follows.

Step 1: first, the three co-planar neighbors of the current node in the upper, right and back directions are considered. There are a total of 2³=8 possible occupancy statuses of the three co-planar neighbors in the upper, right and back directions of the current node. A context is assigned to each case where not all neighbors are unoccupied. Then, considering that the child node to be encoded is located at the position of the current node, the group of neighboring nodes provides a total of (8−1)×8=56 contexts. If all three co-planar neighbors in the upper, right and back directions of the current node are unoccupied, the remaining three groups of neighbors of the current node layer are continued to be considered.

Step 2: a distance between the nearest occupied node and the current node is considered.

Exemplarily, the corresponding relationship between neighboring node distribution and distance is shown in Table 3.

TABLE 3

| Occupancy status of current node level | Distance |
|---|---|
| Left, front and bottom co-planar neighbor occupied | 1 |
| or right, uppe rand back co-edge neighbor occupied | |
| Left, front and bottom co-planar neighbor and right, | 2 |
| upper and back co-edge neighbor unoccupied, and | |
| left, front and bottom co-edge neighbor occupied | |
| All four groups of neighbors in current node level | 3 |
| unoccupied | |

From Table 1, it is to be seen that the distance has 3 values. One context is assigned to each of the 3 value cases, and then the case in which the child node to be encoded is located in the position of the current node is considered, the total number of contexts is 3×8=24.

So far, this set of context models is assigned a total of 128+56+24=208 contexts.

In the embodiments of the present disclosure, for the context model 2, the method adopts a two-level context reference relationship configuration, as shown in formula (7), the first level is the occupancy status of the adjacent encoded blocks of the parent node of the current sub-block to be encoded (i.e., ctxIdxParent), and the second level is the occupancy status of the adjacent encoded blocks at the same depth as the current sub-block to be encoded (i.e., ctxIdxChild).

$$idx = L U T [ ctxIdxParent ] [ ctxIdxChild ] \qquad ( 7 )$$

First, for each sub-block to be encoded, the ctxIdxChild in the second level is as shown in formula (8), Cᵢ¹ represents the occupancy statuses of three encoded sub-blocks whose distance from the current sub-block [symbol] ₂ is 1.

$$ctxIdxChild = ( {\sum }_{i = 0}^{2} {2}^{i} {C}_{i}^{1} ) \qquad ( 8 )$$

Secondly, for the relative positions of different sub-blocks in the first layer, the co-planar and co-edge adjacent parent blocks are found by table lookup, and ctxIdxParent of the first level is calculated based on their occupancy status and formula (8). As illustrated in FIG. 23, each sub-picture illustrates the relative position relationship of six adjacent parent blocks found for the i-th child block, including three co-planar parent blocks (P_{i,0}, P_{i,1}, P_{i,2}) and three co-edge parent blocks (P_{i,3}, P_{i,4}, P_{i,5}). The position relationship between each child block and its adjacent parent block is obtained by the method in Table 3.

Further, FIG. 24 is a schematic diagram of adjacent blocks corresponding to a current block to be encoded. As illustrated in FIG. 24, around eighteen adjacent blocks used by the current block to be encoded as well as their Morton numbers are illustrated. The numbers in Table 4 correspond to the Morton numbers in FIG. 24, and this method takes into account the positions of different sub-blocks and the central rotational symmetry in geometry. As can be seen from FIG. 24, taking the current block as the center, this method has a larger receptive field and may utilize up to eighteen around encoded adjacent parent blocks. The method used in formula (8) is the permutation and combination of the occupancy statuses of the three co-planar parent blocks, and the sum of the occupancy statuses of the three co-edge parent blocks.

TABLE 4

| P_{i, j} | j = 0 | j = 1 | j = 2 | j = 4 | j = 5 |
|---|---|---|---|---|---|
| i = 0 | 4 | 10 | 12 | 1 | 9 |
| i = 1 | 4 | 10 | 14 | 1 | 11 |
| i = 2 | 4 | 16 | 12 | 7 | 15 |
| i = 3 | 4 | 16 | 14 | 7 | 17 |
| i = 4 | 22 | 10 | 12 | 19 | 9 |
| i = 5 | 22 | 10 | 14 | 19 | 11 |
| i = 6 | 22 | 16 | 12 | 25 | 15 |
| i = 7 | 22 | 16 | 14 | 25 | 17 |

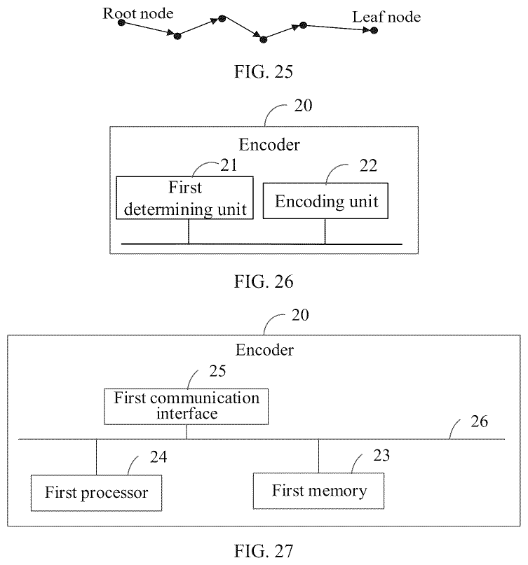

Further, if predictive tree coding is adopted, the geometry information of the point cloud is first adopted to perform Morton code sorting at the encoding side, and then predictive coding is performed on the geometry information of the point cloud using KD-Tree, which is similar to a single chain structure which predictive coding is performed on the geometry information of the child node by using the parent node. For example, FIG. 25 is a schematic diagram of a predictive tree. As illustrated in FIG. 25, the predictive tree adopts a single chain structure. Except for the only leaf node, each tree node has only one child node. Except for the root node which is predicted by the default value, other nodes are provided with geometry prediction values by their parent nodes.

Step 203: a prediction value of a node in the current node group is determined according to the coding mode; and mode flag information corresponding to the current node group is determined according to the coding mode, and the mode flag information is signalled into the bitstream.

In the embodiments of the present disclosure, after determining the coding mode corresponding to the current node group among the at least one node group, the prediction value of the node in the current node group may be determined according to the coding mode; and the mode flag information corresponding to the current node group may be determined according to the coding mode, and the mode flag information is signalled into the bitstream.

It is to be understood that in the embodiments of the present disclosure, for the G-PCC encoding and decoding framework, in response to determining that the geometry information for each node in the current node group is encoded using the octree encoding, the mode flag information is determined based on the octree coding, and the mode flag information is signalled into the bitstream.

Further, in the embodiments of the present disclosure, after the prediction value of the node in the current node group is determined according to the coding mode, each node in the node group corresponds to a respective prediction value.

For example, in the embodiments of the present disclosure, for the G-PCC encoding and decoding framework, since the coding mode is the octree coding, and the current node group includes eight nodes, after the prediction value of each node in the current node group is determined using octree coding, eight prediction values may be obtained, which correspond to the eight nodes, respectively.

That is, in the embodiments of the present disclosure, for the G-PCC encoding and decoding framework, at the encoding side, the nodes in the level to be encoded are partitioned first to obtain different Groups. Before encoding the geometry information of each Group, the coding mode of the current Group is encoded first, and then, the prediction value of the node in the current node group is determined according to the coding mode; and the mode flag information corresponding to the current node group is determined according to the coding mode, and the mode flag information is signalled into the bitstream, so that the geometry coding efficiency of the point cloud may be improved.

It is to be understood that in the embodiments of the present disclosure, for the AVS-PCC encoding and decoding framework, in response to the coding mode being the first context coding, the geometry information for each node in the current node group is encoded according to the first context coding to obtain the prediction value; or in response to the coding mode being the second context coding, the geometry information for each node in the current node group is encoded using the second context to obtain the prediction value. The corresponding mode flag information is determined and signalled into the bitstream.

That is, in the embodiments of the present disclosure, at the encoding side, for the AVS-PCC encoding and decoding framework, the nodes in the level to be encoded are partitioned first to obtain different Groups. Before encoding the geometry information of each Group, it is necessary to determine whether the current Group adopts the context coding model 1 or context coding model 2 according to the coding mode of the current Group, so that the geometry coding efficiency of the point cloud may be improved.

In addition, in the embodiments of the present disclosure, as illustrated in FIG. 19, the decoder may further decode the bitstream to determine first flag information (Step 104). In response to a value of the first flag information being a fifth value, a partitioning procedure of the at least one node group and a determining procedure of the mode flag information are performed (Step 105) to improve the geometry coding efficiency of the point cloud. In response to a value of the first flag information being a sixth value, prediction values of the nodes to be processed are determined according to a preset decoding mode (Step 106).

It is to be understood that in the embodiments of the present disclosure, the preset decoding mode may be a decoding mode other than the partitioning procedure based on the node group and the determining procedure of the mode flag information in the present disclosure, which is not limited in the present disclosure.

It is to be noted that, in the embodiments of the present disclosure, the first flag information may be information at any layer level. For example, the first flag information may be at a frame layer level, a group layer level, a slice layer level, or the like.

It is to be noted that, in the embodiments of the present disclosure, the layer level of the first flag information depends on a scale of the point cloud data being processed. For example, when decoding one point cloud picture, the first flag information may be at the frame layer level; when partitioning the node groups using the node group partitioning process proposed in the embodiments of the present disclosure, the first flag information may be at the group layer level.

Further, in some embodiments of the present disclosure, for the G-PCC encoding and decoding framework, an initial length parameter may further be determined. Based on the initial length parameter, an optimal partitioning mode and at least one node group corresponding to the optimal partitioning mode are determined using a recursive algorithm. For a current node group among the at least one node group corresponding to the optimal partitioning mode, a fifth cost value of encoding geometry information for nodes in the current node group using octree coding and a sixth cost value of encoding geometry information for the nodes in the current node group using planar coding are determined using a rate distortion optimization algorithm. In response to the fifth cost value being less than or equal to the sixth cost value, it is determined that a coding mode corresponding to the current node group is the octree coding; or in response to the fifth cost value being greater than the sixth cost value, it is determined that a coding mode corresponding to the current node group is the planar coding.

It is to be noted that, in the embodiments of the present disclosure, the initial length parameter may be determined according to the number of the nodes to be processed.

For example, in the embodiments of the present disclosure, at the encoding side, adaptive partitioning may be performed on the nodes in the coding level to be encoded using the rate distortion optimization selection algorithm, and then the rate distortion optimization is performed to select the optimal coding mode in each Group. Exemplarily, assuming that the number of the nodes in the current coding level is nodeCount, the maximum Length of the initialized Group is nodeCount (initial length parameter), and then the optimal Group partitioning mode and the optimal coding mode of each Group are adaptively selected based on the recursive algorithm:

```
  Const uint minLength=M; (M=16)
  Uint curBestCost=0;
  Bool curCodeMode=0;
  Vector<pair<int,bool>>divideLength;
  Uint RDOSelector(Uint startIdx, Uint endIdx, Uint &curBestCost,
  Bool& curCodeMode){
      Uint curOctreeCost=0;
      For(int nodeIdx=0;nodeIdx<nodeCount;++nodeIdx)
          curOctreeCost+= estimateOcctreeCodingBits
          (node[nodeIdx]);
        Uint curPlanarCost=0;
      For(int nodeIdx=0;nodeIdx<nodeCount;++nodeIdx)
          curPlanarCost += estimatePlanarCodingBits
          (node[nodeIdx]);
      if(curPlanarCost< curOctreeCost){
        curCodeMode=1; curBestCost= curPlanarCost;}
      else{
        curCodeMode=1; curBestCost= curPlanarCost;}
      if(endIdx − startIdx<= minLength)
        return { curBestCost , curCodeMode};
      ///< divide current Group
          Uint curLeftChildBestCost=0;
      Bool curLeftChildCodeMode=0;
      RDOSelector(startIdx, startIdx+(endIdx−startIdx)/2,
      curLeftChildBestCost,
curLeftChildCodeMode);
      Uint curRightChildBestCost=0;
      Bool curRightChildCodeMode=0;
      RDOSelector( startIdx+(endIdx−startIdx)/2,endIdx,
      curRightChildBestCost,
curRightChildCodeMode);
      If(curLeftChildBestCost+ curRightChildBestCost< curBestCost){
      divideLength.push_back({curLeftChildBestCost ,
      curLeftChildCodeMode });
        divideLength.push_back({curRightChildBestCost ,
curRightChildCodeMode });}
  else
      divideLength.push_back({curBestCost , curCodeMode });
    }
```

Further, in the embodiments of the present disclosure, for the AVS-PCC encoding and decoding framework, an initial length parameter may further be determined. Based on the initial length parameter, an optimal partitioning mode and at least one node group corresponding to the optimal partitioning mode are determined using a recursive algorithm. For a current node group among the at least one node group corresponding to the optimal partitioning mode, a seventh cost value of encoding geometry information for nodes in the current node group using first context and an eighth cost value of encoding geometry information for the nodes in the current node group using first context are determined using a rate distortion optimization algorithm. In response to the seventh cost value being less than or equal to the eighth cost value, it is determined that a coding mode corresponding to the current node group is the first context encoding; or in response to the seventh cost value being greater than the eighth cost value, it is determined that a coding mode corresponding to the current node group is the second context encoding.

For example, in some embodiments of the present disclosure, at the encoding side, adaptive partitioning may be performed on the nodes in the coding level to be encoded using the rate distortion optimization selection algorithm, and then the rate distortion optimization is performed in each Group, to select the optimal coding mode. Exemplarily, assuming that the number of nodes in the current coding level is nodeCount, the maximum Length of the initialized Group is nodeCount, and then the optimal Group partitioning mode and the optimal coding mode of each Group are adaptively selected based on the recursive algorithm:

```
  Const uint minLength=M; (M=16)
  Uint curBestCost=0;
  Bool curCodeMode=0;
  Vector<pair<int,bool>>divideLength;
  Uint RDOSelector(Uint startIdx, Uint endIdx, Uint &curBestCost,
  Bool& curCodeMode){
      Uint curOctreeCost=0;
      For(int nodeIdx=0;nodeIdx<nodeCount;++nodeIdx)
          curOctreeCost+= estimateOcctreeCodingBits
          (node[nodeIdx]);
        Uint curPlanarCost=0;
      For(int nodeIdx=0;nodeIdx<nodeCount;++nodeIdx)
          curPlanarCost += estimatePlanarCodingBits
          (node[nodeIdx]);
      if(curPlanarCost< curOctreeCost){
        curCodeMode=1; curBestCost= curPlanarCost;}
      else{
        curCodeMode=1; curBestCost= curPlanarCost;}
      if(endIdx − startIdx<= minLength)
        return { curBestCost , curCodeMode};
      ///< divide current Group
        Uint curLeftChildBestCost=0;
      Bool curLeftChildCodeMode=0;
      RDOSelector(startIdx, startIdx+(endIdx−startIdx)/2,
      curLeftChildBestCost,
curLeftChildCodeMode);
        Uint curRightChildBestCost=0;
      Bool curRightChildCodeMode=0;
      RDOSelector( startIdx+(endIdx−startIdx)/2,endIdx,
      curRightChildBestCost,
curRightChildCodeMode);
      If(curLeftChildBestCost+ curRightChildBestCost< curBestCost){
      divideLength.push_back({curLeftChildBestCost ,
      curLeftChildCodeMode });
        divideLength.push_back({curRightChildBestCost ,
curRightChildCodeMode });}
      else
      divideLength.push_back({curBestCost , curCodeMode });
    }
```

Further, in the embodiments of the present disclosure, in the AVS-PCC encoder, different LCU coding units may be obtained first by using octree partitioning, and then, at the encoding side, predictive tree coding or multiway-tree coding is adaptively selected for each LCU coding unit by using simple point cloud density. Similarly, the optimal coding mode may be selected adaptively using the rate distortion optimization algorithm, and predictive tree mode, multiway-tree coding model 1 or multiway-tree coding model 2 may be selected for encoding by using the rate distortion optimization selection algorithm, so that the geometry information coding efficiency of the point cloud is improved.

It is to be seen that in the embodiments of the present disclosure, the current level to be encoded are partitioned at the encoding side, to obtain different Groups; next, the optimal coding mode of each Group is selected for each Group at the encoding side using the rate distortion optimization criterion, and then the optimal coding mode is used to adaptively encode the nodes of the current Group, so that the geometry coding efficiency of point clouds is improved.

In some embodiments, geometry coding lossless and attribute information coding lossless are used as the test conditions. Bpp is the performance measurement indicator of geometry lossless coding, and 100% is the coding efficiency. The above Table 1 shows the compression performance of a single sequence, and Table 2 shows the performance results under lossless geometry and lossless attributes. It can be seen that in the case of geometry lossless coding, the compression efficiency may reach nearly 20% on some sequences in the embodiments of the present disclosure.

To sum up, in the embodiments of the present disclosure, partitioning processing is performed on the nodes to be processed obtained after octree partitioning, to obtain the at least one node group, where the manners for partitioning the node groups are not specifically limited by the present disclosure, so as to adaptively select the encoding mode suitable for each node group, including octree encoding, planar encoding, first context encoding, and second context encoding, or the like. In this way, the different node groups are encoded according to the different encoding modes, so that the geometry information coding efficiency in each node group may be ensured to achieve local optimum, the geometry coding efficiency of the point cloud is greatly improved, thereby improving the encoding and decoding performance of the point cloud.

The embodiments of the present disclosure provide an encoding method. An encoder performs partitioning processing on the nodes to be processed to determine the at least one node group corresponding to the nodes to be processed; determines the coding mode corresponding to the current node group among the at least one node group, determines the prediction value of the node in the current node group according to the coding mode, determines the mode flag information corresponding to the current node group according to the coding mode, and signals the mode flag information into the bitstream. It can be seen that the nodes to be processed may be partitioned into different node groups, and then for each different node group, the coding mode suitable for the node group may be selected, so that the corresponding prediction value may be determined based on the coding mode suitable for the node group, thereby effectively improving the geometry coding efficiency of the point cloud, and then improving the encoding and decoding performance of the point cloud.

Based on the above embodiments, in another embodiment of the present disclosure, based on the same inventive concept as the above embodiments, FIG. 26 is a first schematic diagram of a composition structure of an encoder. As illustrated in FIG. 26, the encoder 20 may include: a first determining unit 21 and an encoding unit 22.

The first determining unit 21 is configured to perform partitioning processing on nodes to be processed to determine at least one node group corresponding to the nodes to be processed; and determine a coding mode corresponding to a current node group among the at least one node group.

The encoding unit 22 is configured to determine a prediction value of a node in the current node group according to the coding mode; and determine mode flag information corresponding to the current node group according to the coding mode, and signal the mode flag information into a bitstream.

In some embodiments, the first determining unit 21 is further configured to set, in response to determining that the coding mode indicated by the mode flag information is octree coding, a value of the mode flag information to a first value; or set, in response to determining that the coding mode indicated by the mode flag information is planar coding, a value of the mode flag information to a second value.

In some embodiments, the first determining unit 21 is further configured to set, in response to determining that the coding mode indicated by the mode flag information is first context encoding, a value of the mode flag information to a third value; or set, in response to determining that the coding mode indicated by the mode flag information is second context encoding, a value of the mode flag information to a fourth value.

In some embodiments, the first determining unit 21 is further configured to determine nodes in a level obtained after octree partitioning as one node group.

In some embodiments, the first determining unit 21 is further configured to determine nodes in a level obtained after octree partitioning as a plurality of node groups.

In some embodiments, the first determining unit 21 is further configured to perform adaptive partitioning processing on the nodes to be processed according to a rate distortion optimization algorithm, to determine the at least one node group.

In some embodiments, the number of nodes in each different node group among the at least one node group is less than or equal to a preset threshold.

In some embodiments, the numbers of nodes in different node groups among the at least one node group are not all identical.

In some embodiments, the first determining unit 21 is further configured to determine length information corresponding to the current node group according to a number of nodes in the current node group among the at least one node group, and signal the length information into the bitstream.

In some embodiments, the first determining unit 21 is further configured to determine, using a rate distortion optimization algorithm, a first cost value of encoding geometry information for nodes in the current node group using octree coding and a second cost value of encoding geometry information for the nodes in the current node group using planar coding; and in response to the first cost value being less than or equal to the second cost value, determine that the coding mode corresponding to the current node group is the octree coding; or in response to the first cost value being greater than the second cost value, determine that the coding mode corresponding to the current node group is the planar coding.

In some embodiments, the first determining unit 21 is further configured to determine, using a rate distortion optimization algorithm, a third cost value of encoding geometry information for nodes in the current node group using first context and a fourth cost value of encoding geometry information for the nodes in the current node group using second context; and in response to the third cost value being less than or equal to the fourth cost value, determine that the coding mode corresponding to the current node group is the first context encoding; or in response to the third cost value being greater than the fourth cost value, determine that the coding mode corresponding to the current node group is the second context encoding.

In some embodiments, the first determining unit 21 is further configured to determine an initial length parameter; determine, based on the initial length parameter, an optimal partitioning mode and at least one node group corresponding to the optimal partitioning mode using a recursive algorithm; for a current node group among the at least one node group corresponding to the optimal partitioning mode, determine, using a rate distortion optimization algorithm, a fifth cost value of encoding geometry information for nodes in the current node group using octree coding and a sixth cost value of encoding geometry information for the nodes in the current node group using planar coding; and in response to the fifth cost value being less than or equal to the sixth cost value, determine that a coding mode corresponding to the current node group is the octree coding; or in response to the fifth cost value being greater than the sixth cost value, determine that a coding mode corresponding to the current node group is the planar coding.

In some embodiments, the first determining unit 21 is further configured to determine an initial length parameter; determine, based on the initial length parameter, an optimal partitioning mode and at least one node group corresponding to the optimal partitioning mode using a recursive algorithm; for a current node group among the at least one node group corresponding to the optimal partitioning mode, determine, using a rate distortion optimization algorithm, a seventh cost value of encoding geometry information for nodes in the current node group using first context and an eighth cost value of encoding geometry information for the nodes in the current node group using second context; and in response to the seventh cost value being less than or equal to the eighth cost value, determine that a coding mode corresponding to the current node group is the first context encoding; or in response to the seventh cost value being greater than the eighth cost value, determine that a coding mode corresponding to the current node group is the second context encoding.

It is to be understood that in the present embodiment, the “unit” may be part of a circuit, part of a processor, part of a program or software, or the like, and may also be a module or may be non-modular. Moreover, various components in the present embodiment may be integrated into one processing unit, or each unit may be physically present alone, or two or more units may be integrated into one unit. The above integrated unit may be implemented in the form of hardware or software function modules.

The integrated unit may be stored in a computer readable storage when it is implemented in the form of software functional modules and is not sold or used as a separate product. Based on such understanding, the technical solutions of the embodiments essentially, or the part of the technical solutions that contributes to the related art, or all or part of the technical solutions, may be embodied in the form of a computer software product which is stored in a storage medium and includes instructions for causing a computer device (which may be a personal computer, a server, or a network device and so on) or a processor to perform all or part of the steps described in the various embodiments of the present application. The above storage medium includes various media that can store program codes, such as a USB flash drive (U disk), a mobile hard disk, a read only memory (ROM), a random access memory (RAM), a diskette, or an optical disk.

Therefore, the embodiments of the present disclosure provide a non-transitory computer-readable storage medium, which is applied to the encoder 20. The non-transitory computer-readable storage medium has a computer program stored thereon, and the computer program, when executed by the first processor, implements the method described in any one of the above embodiments.

Based on the above composition of the encoder 20 and the non-transitory computer-readable storage medium, FIG. 27 is a second schematic diagram of a composition structure of the encoder. As illustrated in FIG. 27, the encoder 20 may include: a first memory 23, a first processor 24, a first communication interface 25 and a first bus system 26. The first memory 23, the first processor 24 and the first communication interface 25 are coupled together via the first bus system 26. It is to be understood that the first bus system 26 is configured to achieve connection and communication between these components. In addition to a data bus, the first bus system 26 further includes a power bus, a control bus and a status signal bus. However, for the sake of clarity, various buses are labeled as the first bus system 26 in FIG. 27.

The first communication interface 25 is configured to receive and transmit signals in the process of transmitting and receiving information with other external network elements.

The first memory 23 is configured to store a computer program executable on the first processor.

The first processor 24 is configured to perform, when running the computer program, partitioning processing on nodes to be processed to determine at least one node group corresponding to the nodes to be processed; and determine a coding mode corresponding to a current node group among the at least one node group; and determine a prediction value of a node in the current node group according to the coding mode; and determine mode flag information corresponding to the current node group according to the coding mode, and signal the mode flag information into a bitstream.

It can be understood that the first memory 23 in the embodiments of the present disclosure may be a volatile memory or a non-volatile memory, or may include both volatile and non-volatile memories. Here, the non-volatile memory may be a read-only memory (ROM), a programmable ROM (PROM), an erasable PROM (EPROM), an electrically EPROM (EEPROM) or a flash memory. The volatile memory may be a random access memory (RAM), which is used as an external cache. Through illustrative, rather than limiting illustration, many forms of RAMs are available, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM) and a direct rambus RAM (DRRAM). The first memory 23 of the systems and methods described by the present disclosure is intended to include, but is not limited to, these and any other suitable types of memories.

The first processor 24 may be an integrated circuit chip having a signal processing capability. In the implementation process, various steps of the above method may be completed by an integrated logic circuit of hardware in the first processor 24 or an instruction in the form of software. The first processor 24 mentioned above may be a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component. Various methods, steps and logical block diagrams disclosed in the embodiments of the present disclosure may be implemented or performed. A general-purpose processor may be a microprocessor, or the processor may also be any conventional processor, etc. The steps of the method disclosed in combination with the embodiments of the present disclosure may be directly embodied as being performed and completed by a hardware decoding processor, or by using a combination of hardware and software modules in the decoding processor. The software module may be located in the mature storage medium in the art such as the random memory, the flash memory, the read-only memory, the programmable read-only memory or electrically erasable programmable memory, the register. The storage medium is located in the first memory 23, and the first processor 24 reads the information in the first memory 23 and completes the steps of the above methods in combination with its hardware.

It is to be understood that the embodiments described in the present disclosure may be implemented by hardware, software, firmware, middleware, microcode, or a combination thereof. For hardware implementation, the processing unit may be implemented in one or more application specific integrated circuits (ASIC), digital signal processors (DSP), digital signal processing devices (DSPD), programmable logic devices (PLD), field programmable gate arrays (FPGA), general-purpose processors, controllers, microcontrollers, microprocessors, other electronic units for performing the functions described in the present disclosure, or combinations thereof. For software implementation, the technology described in the present disclosure may be implemented through modules (e.g., procedures, functions) that perform the functions described in the present disclosure. The software codes may be stored in a memory and executed by a processor. The memory may be implemented within the processor or external to the processor.

Optionally, as another embodiment, the first processor 24 is further configured to perform the method described in any one of the above embodiments when running the computer program.

The embodiments of the present disclosure provide an encoder. The encoder performs partitioning processing on the nodes to be processed to determine the at least one node group corresponding to the nodes to be processed; determines the coding mode corresponding to the current node group among the at least one node group, determines the prediction value of the node in the current node group according to the coding mode, determines the mode flag information corresponding to the current node group according to the coding mode, and signals the mode flag information into the bitstream. It can be seen that the nodes to be processed may be partitioned into different node groups, and then for each different node group, the coding mode suitable for the node group may be selected, so that the corresponding prediction value may be determined based on the coding mode suitable for the node group, thereby effectively improving the geometry coding efficiency of the point cloud, and then improving the encoding and decoding performance of the point cloud.

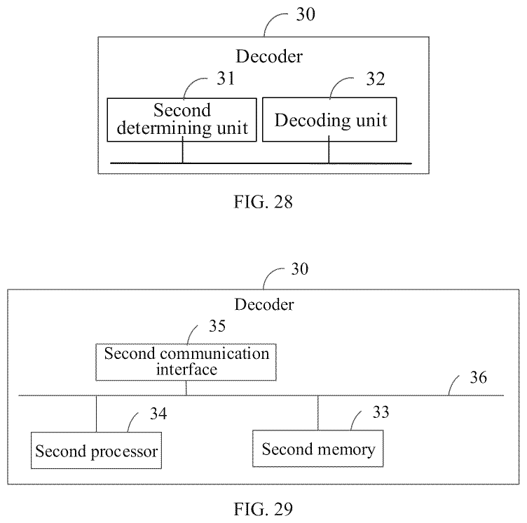

FIG. 28 is a first schematic diagram of a composition structure of a decoder. As illustrated in FIG. 28, the decoder 30 may include: a second determining unit 31 and a decoding unit 32.

The second determining unit 31 is configured to perform partitioning processing on nodes to be processed to determine at least one node group corresponding to the nodes to be processed.

The decoding unit 32 is configured to decode a bitstream to determine mode flag information corresponding to a current node group among the at least one node group; and determine a prediction value of a node in the current node group according to a decoding mode indicated by the mode flag information.

In some embodiments, the second determination unit 31 is further configured to determine, in response to a value of the mode flag information being a first value, that the decoding mode indicated by the mode flag information is octree decoding; or determine, in response to a value of the mode flag information being a second value, that the decoding mode indicated by the mode flag information is planar decoding.

In some embodiments, the second determination unit 31 is further configured to determine, in response to a value of the mode flag information being a third value, determining that the decoding mode indicated by the mode flag information is first context decoding; or determine, in response to a value of the mode flag information being a fourth value, determining that the decoding mode indicated by the mode flag information is second context decoding.

In some embodiments, the second determining unit 31 is further configured to determine nodes in a level obtained after octree partitioning as one node group.

In some embodiments, the second determining unit 31 is further configured to determine nodes in a level obtained after octree partitioning as a plurality of node groups.

In some embodiments, the second determining unit 31 is further configured to perform adaptive partitioning processing on the nodes to be processed according to a rate distortion optimization algorithm, to determine the at least one node group.

In some embodiments, the number of nodes in each different node group among the at least one node group is less than or equal to a preset threshold.

In some embodiments, the numbers of nodes in different node groups among the at least one node group are not all identical.

In some embodiments, the decoding unit 32 is further configured to decode the bitstream to determine length information corresponding to the current node group among the at least one node group.

In some embodiments, the second determining unit 31 is further configured to determine a number of nodes in the current node group according to the length information.

In some embodiments, the decoding unit 32 is further configured to decode, in response to the decoding mode indicated by the mode flag information being the octree decoding, geometry information for each node in the current node group using octree; or decode, in response to the decoding mode indicated by the mode flag information being the planar decoding, geometry information for each node in the current node group using planar decoding.

In some embodiments, the decoding unit 32 is further configured to decode, in response to the decoding mode indicated by the mode flag information being the first context decoding, geometry information for each node in the current node group using first context; or decode, in response to the decoding mode indicated by the mode flag information being second context decoding, geometry information for each node in the current node group using second context.

In some embodiments, the decoding unit 32 is further configured to decode the bitstream to determine first flag information.

In some embodiments, the second determination unit 31 is further configured to perform, in response to a value of the first flag information being a fifth value, a partitioning procedure of the at least one node group and a determining procedure of the mode flag information; or determine, in response to a value of the first flag information being a sixth value, prediction values of the nodes to be processed according to a preset decoding mode.

It is to be understood that in the present embodiment, the “unit” may be part of a circuit, part of a processor, part of a program or software, or the like, and may also be a module or may be non-modular. Moreover, various components in the present embodiment may be integrated into one processing unit, or each unit may be physically present, or two or more units may be integrated into one unit. The above integrated unit may be implemented in the form of hardware or a software function module.

The integrated unit may be stored in a computer readable storage when it is implemented in the form of a software functional module and is sold or used as a separate product. Based on such understanding, the technical solutions of the embodiments essentially, or the part of the technical solutions that contributes to the related art, or all or part of the technical solutions, may be embodied in the form of a computer software product which is stored in a storage medium and includes instructions for causing a computer device (which may be a personal computer, a server, or a network device and so on) or a processor to perform all or part of the steps described in the various embodiments of the present application. The above storage medium includes various media that can store program codes, such as a USB flash drive (U disk), a mobile hard disk, a read only memory (ROM), a random access memory (RAM), a diskette, or an optical disk.

Therefore, the embodiments of the present disclosure provide a non-transitory computer-readable storage medium, which is applied to the decoder 30. The non-transitory computer-readable storage medium has a computer program stored thereon, and the computer program, when executed by the second processor, implements the method described in any one of the above embodiments.

Based on the above composition of the decoder 30 and the non-transitory computer-readable storage medium, FIG. 29 is a second schematic diagram of a composition structure of the decoder. As illustrated in FIG. 29, the decoder 30 may include: a second memory 33, a second processor 34, a second communication interface 35 and a second bus system 36. The second memory 33, the second processor 34 and the second communication interface 35 are coupled together via the second bus system 36. It is to understood that the second bus system 36 is used to achieve connection and communication between these components. In addition to a data bus, the second bus system 36 further includes a power bus, a control bus and a status signal bus. However, for the sake of clarity, various buses are labeled as the second bus system 36 in FIG. 29.

The second communication interface 35 is configured to receive and transmit signals in the process of transmitting and receiving information with other external network elements.

The second memory 33 is configured to store a computer program executable on the second processor.

The second processor 34 is configured to perform, when running the computer program, partitioning processing on nodes to be processed to determine at least one node group corresponding to the nodes to be processed, decode the bitstream to determine the mode flag information corresponding to the current node group among the at least one node group, and determine the prediction value of the node in the current node group according to the decoding mode indicated by the mode flag information.

It can be understood that the second memory 33 in the embodiments of the present disclosure may be a volatile memory or a non-volatile memory, or may include both volatile and non-volatile memories. Here, the non-volatile memory may be a read-only memory (ROM), a programmable ROM (PROM), an erasable PROM (EPROM), an electrically EPROM (EEPROM) or a flash memory. The volatile memory may be a random access memory (RAM), which is used as an external cache. Through illustrative, rather than limiting illustration, many forms of RAMs are available, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM) and a direct rambus RAM (DR RAM). The second memory 33 of the systems and methods described by the present disclosure is intended to include, but is not limited to, these and any other suitable types of memories.

The second processor 34 may be an integrated circuit chip having a signal processing capability. In the implementation process, various steps of the above method may be completed by an integrated logic circuit of hardware in the second processor 34 or an instruction in the form of software. The second processor 34 mentioned above may be a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component. Various methods, steps and logical block diagrams disclosed in the embodiments of the present disclosure may be implemented or performed. A general-purpose processor may be a microprocessor, or the processor may also be any conventional processor, etc. The steps of the method disclosed in combination with the embodiments of the present disclosure may be directly embodied as being performed and completed by a hardware decoding processor, or by using a combination of hardware and software modules in the decoding processor. The software module may be located in the mature storage medium in the art such as the random memory, the flash memory, the read-only memory, the programmable read-only memory or electrically erasable programmable memory, the register. The storage medium is located in the second memory 33, and the second processor 34 reads the information in the second memory 33 and completes the steps of the above methods in combination with its hardware.

It is to be understood that the embodiments described in the present disclosure may be implemented by hardware, software, firmware, middleware, microcode, or a combination thereof. For hardware implementation, the processing unit may be implemented in one or more application specific integrated circuits (ASIC), digital signal processors (DSP), digital signal processing devices (DSPD), programmable logic devices (PLD), field programmable gate arrays (FPGA), general-purpose processors, controllers, microcontrollers, microprocessors, other electronic units for performing the functions described in the present disclosure, or combinations thereof. For software implementation, the technology described in the present disclosure may be implemented through modules (e.g., procedures, functions) that perform the functions described in the present disclosure. The software codes may be stored in a memory and executed by a processor. The memory may be implemented within the processor or external to the processor.

The embodiments of the present disclosure provide a decoder. The decoder performs partitioning processing on the nodes to be processed to determine the at least one node group corresponding to the nodes to be processed; decodes the bitstream to determine the mode flag information corresponding to the current node group among the at least one node group; and determines the prediction value of the node in the current node group according to the decoding mode indicated by the mode flag information. It can be seen that the nodes to be processed may be partitioned into different node groups, and then for each different node group, the coding mode suitable for the node group may be selected, so that the corresponding prediction value may be determined based on the coding mode suitable for the node group, thereby effectively improving the geometry coding efficiency of the point cloud, and then improving the encoding and decoding performance of the point cloud.

In another embodiment of the present disclosure, the embodiments of the present disclosure further provide a bitstream, which is generated by bit encoding according to the information to be encoded; where the information to be encoded includes at least: mode flag information and first flag information.

It should be noted that, in the embodiments of the present disclosure, the terms “comprising”, “including” or any other variations thereof are intended to encompass a non-exclusive inclusion, so that a process, method, article or apparatus including a series of elements includes not only those elements, but also other elements not explicitly listed, or also includes elements inherent of such process, method, article or apparatus. Without more constraints, an element defined by the phrase “comprising a . . . ” does not exclude the presence of other identical elements in the process, method, article or apparatus comprising the element.

The serial numbers of the above embodiments of the present disclosure are for description only and do not represent the advantages or disadvantages of the embodiments.

The methods disclosed in several method embodiments provided in the present disclosure may be arbitrarily combined without conflict to obtain new method embodiments.

The features disclosed in several product embodiments provided in the present disclosure may be arbitrarily combined without conflict to obtain new product embodiments.

The features disclosed in several method or device embodiments provided in the present disclosure may be arbitrarily combined without conflict to obtain new method embodiments or device embodiments.

In a first clause, provided is a decoding method, in which the method is applied to a decoder and includes:
performing partitioning processing on nodes to be processed to determine at least one node group corresponding to the nodes to be processed;
decoding a bitstream to determine mode flag information corresponding to a current node group among the at least one node group; and
determining a prediction value of a node in the current node group according to a decoding mode indicated by the mode flag information.

In a second clause, according to method of the first clause, the method further includes:
in response to a value of the mode flag information being a first value, determining that the decoding mode indicated by the mode flag information is octree decoding; or
in response to a value of the mode flag information being a second value, determining that the decoding mode indicated by the mode flag information is planar decoding.

In a third clause, according to the method of the first clause, the method further includes:
in response to a value of the mode flag information being a third value, determining that the decoding mode indicated by the mode flag information is first context decoding; or
in response to a value of the mode flag information being a fourth value, determining that the decoding mode indicated by the mode flag information is second context decoding.

In a fourth clause, according to the method of the second or third clause, where performing partitioning processing on the nodes to be processed to determine the at least one node group corresponding to the nodes to be processed includes:

determining nodes in one level obtained after octree partitioning as one node group.

In a fifth clause, according to the method of the second or third clause, where performing partitioning processing on the nodes to be processed to determine the at least one node group corresponding to the nodes to be processed includes:

determining nodes in one level obtained after octree partitioning as a plurality of node groups.

In a sixth clause, according to the method of the second or third clause, where performing partitioning processing on the nodes to be processed to determine the at least one node group corresponding to the nodes to be processed includes:

performing adaptive partitioning processing on the nodes to be processed according to a rate distortion optimization algorithm, to determine the at least one node group.

In a seventh clause, according to the method of any one of the fourth to sixth clauses, a number of nodes in each different node group among the at least one node group is less than or equal to a preset threshold.

In an eighth clause, according to the method of any one of the fourth to sixth clauses, numbers of nodes in different node groups among the at least one node group are not all identical.

In a ninth clause, according to the method of the eighth clause, the method further includes:
decoding the bitstream to determine length information corresponding to the current node group among the at least one node group; and
determining a number of nodes in the current node group according to the length information.

In a tenth clause, according to the method of the second clause, the method further includes:
in response to the decoding mode indicated by the mode flag information being the octree decoding, decoding geometry information for each node in the current node group using octree; or
in response to the decoding mode indicated by the mode flag information being the planar decoding, decoding geometry information for each node in the current node group using planar decoding.

In an eleventh clause, according to the method of the third clause, the method further includes:
in response to the decoding mode indicated by the mode flag information being the first context decoding, decoding geometry information for each node in the current node group using first context; or
in response to the decoding mode indicated by the mode flag information being second context decoding, decoding geometry information for each node in the current node group using second context.

In a twelfth clause, according to the method of the first clause, the method further includes:
decoding the bitstream to determine first flag information; and
in response to a value of the first flag information being a fifth value, performing a partitioning procedure of the at least one node group and a determining procedure of the mode flag information; or
in response to a value of the first flag information being a sixth value, determining prediction values of the nodes to be processed according to a preset decoding mode.

In a thirteenth clause, provided is an encoding method, in which the method id applied to an encoder and includes:
performing partitioning processing on nodes to be processed to determine at least one node group corresponding to the nodes to be processed;
determining a coding mode corresponding to a current node group among the at least one node group;
determining a prediction value of a node in the current node group according to the coding mode; and
determining mode flag information corresponding to the current node group according to the coding mode, and signalling the mode flag information into a bitstream.

In a fourteenth clause, according to the method of the thirteenth clause, the method further includes:
in response to determining that the coding mode indicated by the mode flag information is octree coding, setting a value of the mode flag information to a first value; or
in response to determining that the coding mode indicated by the mode flag information is planar coding, setting a value of the mode flag information to a second value.

In a fifteenth clause, according to the method of the thirteenth clause, the method further includes:
in response to determining that the coding mode indicated by the mode flag information is first context encoding, setting a value of the mode flag information to a third value; or
in response to determining that the coding mode indicated by the mode flag information is second context encoding, setting a value of the mode flag information to a fourth value.

In a sixteenth clause, according to the method of the fourteenth or fifteenth clause, where performing partitioning processing on the nodes to be processed to determine the at least one node group corresponding to the nodes to be processed includes:

determining nodes in one level obtained after octree partitioning as one node group.

In a seventeenth clause, according to the method of the fourteenth or fifteenth clause, where performing partitioning processing on the nodes to be processed to determine the at least one node group corresponding to the nodes to be processed includes:

determining nodes in one level obtained after octree partitioning as a plurality of node groups.

In an eighteenth clause, according to the method of the fourteenth or fifteenth clause, where performing partitioning processing on the nodes to be processed to determine the at least one node group corresponding to the nodes to be processed includes:

performing adaptive partitioning processing on the nodes to be processed according to a rate distortion optimization algorithm, to determine the at least one node group.

In a nineteenth clause, according to the method of any one of the sixteenth to eighteenth clauses, a number of nodes in each different node group among the at least one node group is less than or equal to a preset threshold.

In a twentieth clause, according to the method any one of the sixteenth to eighteenth clauses, numbers of nodes in different node groups among the at least one node group are not all identical.

In a twenty-first clause, according to the method of the twentieth clause, the method further includes:
determining length information corresponding to the current node group according to a number of nodes in the current node group among the at least one node group; and
signalling the length information into the bitstream.

In a twenty-second clause, according to the method of the fourteenth clause, the method further includes:
determining, using a rate distortion optimization algorithm, a first cost value of encoding geometry information for nodes in the current node group using octree coding and a second cost value of encoding geometry information for the nodes in the current node group using planar coding; and
in response to the first cost value being less than or equal to the second cost value, determining that the coding mode corresponding to the current node group is the octree coding; or
in response to the first cost value being greater than the second cost value, determining that the coding mode corresponding to the current node group is the planar coding.

In a twenty-third clause, according to the method of the fifteenth clause, the method further includes:
determining, using a rate distortion optimization algorithm, a third cost value of encoding geometry information for nodes in the current node group using first context and a fourth cost value of encoding geometry information for the nodes in the current node group using second context; and
in response to the third cost value being less than or equal to the fourth cost value, determining that the coding mode corresponding to the current node group is the first context encoding; or
in response to the third cost value being greater than the fourth cost value, determining that the coding mode corresponding to the current node group is the second context encoding.

In a twenty-fourth clause, according to the method fourteenth clause, the method further includes:
determining an initial length parameter;
determining, based on the initial length parameter, an optimal partitioning mode and at least one node group corresponding to the optimal partitioning mode using a recursive algorithm;
for a current node group among the at least one node group corresponding to the optimal partitioning mode, determining, using a rate distortion optimization algorithm, a fifth cost value of encoding geometry information for nodes in the current node group using octree coding and a sixth cost value of encoding geometry information for the nodes in the current node group using planar coding; and
in response to the fifth cost value being less than or equal to the sixth cost value, determining that a coding mode corresponding to the current node group is the octree coding; or
in response to the fifth cost value being greater than the sixth cost value, determining that a coding mode corresponding to the current node group is the planar coding.

In a twenty-fifth clause, according to the method of the fifteenth clause, the method further includes:
determining an initial length parameter;
determining, based on the initial length parameter, an optimal partitioning mode and at least one node group corresponding to the optimal partitioning mode using a recursive algorithm;
for a current node group among the at least one node group corresponding to the optimal partitioning mode, determining, using a rate distortion optimization algorithm, a seventh cost value of encoding geometry information for nodes in the current node group using first context and an eighth cost value of encoding geometry information for the nodes in the current node group using second context; and
in response to the seventh cost value being less than or equal to the eighth cost value, determining that a coding mode corresponding to the current node group is the first context encoding; or
in response to the seventh cost value being greater than the eighth cost value, determining that a coding mode corresponding to the current node group is the second context encoding.

In a twenty-sixth clause, provided is an encoder, in which the encoder includes: a first determining unit and an encoding unit; where
the first determining unit is configured to perform partitioning processing on nodes to be processed to determine at least one node group corresponding to the nodes to be processed; and determine a coding mode corresponding to a current node group among the at least one node group; and
the encoding unit is configured to determine a prediction value of a node in the current node group according to the coding mode; and determine mode flag information corresponding to the current node group according to the coding mode, and signal the mode flag information into a bitstream.

In a twenty-seventh clause, provided is an encoder, in which the encoder includes: a first memory and a first processor; where
the first memory is configured to store a computer program executable on the first processor; and
the first processor is configured to perform the method of any one of the thirteenth to twenty-fifth clauses when executing the computer program.

In a twenty-eighth clause, provided is a decoder, in which the decoder includes: a second determining unit and a decoding unit; where
the second determining unit is configured to perform partitioning processing on nodes to be processed to determine at least one node group corresponding to the nodes to be processed; and
the decoding unit is configured to decode a bitstream to determine mode flag information corresponding to a current node group among the at least one node group; and determine a prediction value of a node in the current node group according to a decoding mode indicated by the mode flag information.

In a twenty-ninth clause, provided is a decoder, in which the decoder includes: a second memory and a second processor; where
the second memory is configured to store a computer program executable on the second processor; and
the second processor is configured to perform the method of any one of the first to twelfth clauses when executing the computer program.

In a thirtieth clause, provided is a bitstream, where the bitstream is generated by bit encoding based on information to be encoded; and the information to be encoded includes at least: mode flag information and first flag information.

In a thirty-first clause, provided is a computer-readable storage medium, having a computer program stored thereon, where the computer program, when executed, implements the method of any one of the first to twelfth clauses, or implements the method of any one of the thirteenth to twenty-fifth clauses.

The foregoing are merely specific implementations of the present disclosure, but the protection scope of the present disclosure is not limited thereto. Any person skilled in the art may readily conceive variations or substitutions within the technical scope disclosed by the present disclosure, which should be included within the protection scope of the present disclosure. Therefore, the protection scope of the present disclosure shall be subject to the protection scope of the claims.

### INDUSTRIAL APPLICABILITY

The embodiments of the present disclosure provide an encoding and decoding method, an encoder, a decoder and a storage medium. An encoder performs partitioning processing on the nodes to be processed to determine the at least one node group corresponding to the nodes to be processed; determines the coding mode corresponding to the current node group among the at least one node group, determines the prediction value of the node in the current node group according to the coding mode, determines the mode flag information corresponding to the current node group according to the coding mode, and signals the mode flag information into the bitstream. The decoder performs partitioning processing on the nodes to be processed to determine the at least one node group corresponding to the nodes to be processed; decodes the bitstream to determine the mode flag information corresponding to the current node group among the at least one node group; and determines the prediction value of the node in the current node group according to the decoding mode indicated by the mode flag information. It can be seen that the nodes to be processed may be partitioned into different node groups, and then for each different node group, the coding mode suitable for the node group may be selected, so that the corresponding prediction value may be determined based on the coding mode suitable for the node group, thereby effectively improving the geometry coding efficiency of the point cloud, and then improving the encoding and decoding performance of the point cloud.

What is claimed is:

1. A decoding method, applied to a decoder and comprising:
determining nodes in a level obtained after octree partitioning as one node group;
decoding a bitstream to determine mode flag information corresponding to a current node group among at least one node group; and
determining a prediction value of a node in the current node group according to a decoding mode indicated by the mode flag information.

2. The method according to claim 1, further comprising:
in response to a value of the mode flag information being a first value, determining that the decoding mode indicated by the mode flag information is octree decoding; or
in response to a value of the mode flag information being a second value, determining that the decoding mode indicated by the mode flag information is planar decoding.

3. The method according to claim 1, further comprising:
in response to a value of the mode flag information being a third value, determining that the decoding mode indicated by the mode flag information is first context decoding; or
in response to a value of the mode flag information being a fourth value, determining that the decoding mode indicated by the mode flag information is second context decoding.

4. The method according to claim 1, wherein
a number of nodes in each different node group among the at least one node group is less than or equal to a preset threshold.

5. The method according to claim 1, wherein
numbers of nodes in different node groups among the at least one node group are not all identical.

6. The method according to claim 5, further comprising:
decoding the bitstream to determine length information corresponding to the current node group among the at least one node group; and
determining a number of nodes in the current node group according to the length information.

7. The method according to claim 2, further comprising:
in response to the decoding mode indicated by the mode flag information being the octree decoding, decoding geometry information for each node in the current node group using octree; or
in response to the decoding mode indicated by the mode flag information being the planar decoding, decoding geometry information for each node in the current node group using planar decoding.

8. The method according to claim 3, further comprising:
in response to the decoding mode indicated by the mode flag information being the first context decoding, decoding geometry information for each node in the current node group using first context; or
in response to the decoding mode indicated by the mode flag information being second context decoding, decoding geometry information for each node in the current node group using second context.

9. The method according to claim 1, further comprising:
decoding the bitstream to determine first flag information; and
in response to a value of the first flag information being a fifth value, performing a partitioning procedure of the at least one node group and a determining procedure of the mode flag information; or
in response to a value of the first flag information being a sixth value, determining prediction values of the nodes to be processed according to a preset decoding mode.

10. The method according to claim 9, wherein
the fifth value is 1, and the sixth value is 0.

11. An encoding method, applied to an encoder and comprising:
determining nodes in a level obtained after octree partitioning as one node group;
determining a coding mode corresponding to a current node group among at least one node group;
determining a prediction value of a node in the current node group according to the coding mode; and
determining mode flag information corresponding to the current node group according to the coding mode, and signalling the mode flag information into a bitstream.

12. The method according to claim 11, further comprising:
in response to determining that the coding mode indicated by the mode flag information is octree coding, setting a value of the mode flag information to a first value; or
in response to determining that the coding mode indicated by the mode flag information is planar coding, setting a value of the mode flag information to a second value.

13. The method according to claim 11 further comprising:
in response to determining that the coding mode indicated by the mode flag information is first context encoding, setting a value of the mode flag information to a third value; or
in response to determining that the coding mode indicated by the mode flag information is second context encoding, setting a value of the mode flag information to a fourth value.

14. The method according to claim 11, wherein
a number of nodes in each different node group among the at least one node group is less than or equal to a preset threshold.

15. The method according to claim 11, wherein
numbers of nodes in different node groups among the at least one node group are not all identical.

16. The method according to claim 15, further comprising:
determining length information corresponding to the current node group according to a number of nodes in the current node group among the at least one node group; and
signalling the length information into the bitstream.

17. The method according to claim 12, further comprising:
determining, using a rate distortion optimization algorithm, a first cost value of encoding geometry information for nodes in the current node group using octree coding and a second cost value of encoding geometry information for the nodes in the current node group using planar coding; and
in response to the first cost value being less than or equal to the second cost value, determining that the coding mode corresponding to the current node group is the octree coding; or
in response to the first cost value being greater than the second cost value, determining that the coding mode corresponding to the current node group is the planar coding.

18. The method according to claim 13, further comprising:
determining, using a rate distortion optimization algorithm, a third cost value of encoding geometry information for nodes in the current node group using first context and a fourth cost value of encoding geometry information for the nodes in the current node group using second context; and
in response to the third cost value being less than or equal to the fourth cost value, determining that the coding mode corresponding to the current node group is the first context encoding; or
in response to the third cost value being greater than the fourth cost value, determining that the coding mode corresponding to the current node group is the second context encoding.

19. The method according to claim 12, further comprising:
determining an initial length parameter;
determining, based on the initial length parameter, an optimal partitioning mode and at least one node group corresponding to the optimal partitioning mode using a recursive algorithm;
for a current node group among the at least one node group corresponding to the optimal partitioning mode, determining, using a rate distortion optimization algorithm, a fifth cost value of encoding geometry information for nodes in the current node group using octree coding and a sixth cost value of encoding geometry information for the nodes in the current node group using planar coding; and
in response to the fifth cost value being less than or equal to the sixth cost value, determining that a coding mode corresponding to the current node group is the octree coding; or
in response to the fifth cost value being greater than the sixth cost value, determining that a coding mode corresponding to the current node group is the planar coding.

20. A decoder, comprising a second memory and a second processor; wherein
the second memory is configured to store a computer program executable on the second processor; and
the second processor is configured, when executing the computer program, to:
determine nodes in a level obtained after octree partitioning as one node group;
decode a bitstream to determine mode flag information corresponding to a current node group among at least one node group; and
determine a prediction value of a node in the current node group according to a decoding mode indicated by the mode flag information.
